(19) United States
(12) Patent Application Publication
(10) Pub. No.: US 2026/0102940 A1
(43) Pub. Date: Apr. 16, 2026

(54) BUILDING PANEL AND METHOD TO PRODUCE SUCH BUILDING PANEL

(71) Applicant: Välinge Innovation AB, Viken (SE)

(72) Inventors: Christer LUNDBLAD, ÖRKELLJUNGA (SE); Georg VETTER, HÖGANÄS (SE); Mattias SVENSSON, VIKEN (SE)

(73) Assignee: Välinge Innovation AB, Viken (SE)

(21) Appl. No.: 19/356,392

(22) Filed: Oct. 13, 2025

(30) Foreign Application Priority Data
Oct. 16, 2024 (SE) 2451030-7

(51) Int. Cl. B27N 3/04; B27N 3/24; B32B 5/16; B32B 21/02; B32B 21/06; B32B 21/08; B32B 21/14

(52) U.S. Cl. CPC B27N 3/04; B32B 5/16; B32B 21/02; B27N 3/24; B32B 21/06; B32B 21/08; B32B 21/14; B32B 2250/05; B32B 2264/062; B32B 2607/00

(57) ABSTRACT

A building panel, such as a floor panel, a wall panel, or a furniture component, including a multi-layered substrate having a back side layer with lignocellulosic particles and a binder, an intermediate layer with lignocellulosic particles and a binder, arranged on the back side layer, a front side layer with lignocellulosic particles and a binder, arranged on the intermediate layer. The building panel further includes a front cork layer attached to the front side layer of the multi-layered substrate. Also, a method of producing a building panel.

### CROSS REFERENCE

The present application claims the benefit of Swedish Application No. 2451030-7, filed on Oct. 16, 2025. The entire contents of Swedish Application No. 2451030-7 are hereby incorporated herein by reference in their entirety.

### TECHNICAL FIELD

The present disclosure relates to the field of building panels, e.g., floor panels or wall panels, or furniture components, e.g., drawer panels or countertops. The present disclosure further relates to methods of producing such building panels.

### TECHNICAL BACKGROUND

Within the field of building panels there are a number of different boards for forming the carrier board of the building panel. One example is a fibre board. It is a wood composite that is prepared by mixing wood fibres with thermosetting resin. The fibre board is then hot pressed. Fibre boards can be produced with different densities and a fibre board with a density around 600-800 kg/m³ is referred to as a Medium Density Fibre Board (MDF) and a fibre board with a density around 800-1000 kg/m³ is referred to as a High Density Fibre Board (HDF). MDF are usually used within the furniture industry as a replacer for solid wood and the HDF is usually used within the flooring industry. A majority of the wood fibres in both the MDF and the HDF are refined long and thin fibres with an aspect ratio, i.e., a ratio between the length of the fibre and its width, of above 40 and sometimes as much as around 100.

Another example of a board is a particle board which may include a similar raw material as fibre boards, i.e., wood based materials. A difference between the two board types is that the density of a particle board is lower, between 500-750 kg/m³, or about 650 kg/m³. Another difference is that the wood material being used for the particle board production is milled into wood chips of different sizes and not refined into fibres as in the fibre board production.

Both of the above mentioned boards are however not optimal for the development that the building panel industry, and perhaps even more the flooring industry, is facing especially when it comes to more or completely water resistant panels, to lighter and thinner products in order to decrease the material consumption, or to decrease the manufacturing costs as the material prices increase. Other challenges for the flooring industry are to provide panels with properties like sound-attenuating properties, insulating properties and panels having a soft touch.

In order to create a more water resistant building panel the market has tried to incorporate or even switched to thermoplastic material, such as PVC, or used different types of fillers such as Kaolin clay or limestone. Such boards are within the field referred to as LVT, SPC, or WPC. Disadvantages with such boards may be that they are rather expensive and temperature sensitive. Further, the ongoing debate whether thermoplastics, such as PVC, are non-environmentally friendly may also be a disadvantage.

All the above boards may then be combined with various surface materials in order to produce a building panel with a decorative surface. Such surface material may be thermosetting resin impregnated paper, thermoplastic foils, wood veneer, or a printed decorative powder layer. In order to balance a building panel having a surface layer the same type of surface layer is preferably placed on the back side of the building panel as well, which is known in the art.

It is known within the field to apply a surface layer onto a board, usually also with a suitable binder in between the board and the surface layer and apply heat and pressure to form the building panel. This can be made in a continuous pressing device or in a discontinuous pressing device, by a single pressing device or multiple pressing devices.

Wood based building panels are moisture sensitive, and one problem is that the edges between two building panels swell when exposed to water. Further, the bonding between wood particles may be damaged and the initially compressed wood particles may swell. The swelling becomes permanent since there is nothing to compress the particles again when they have dried when the building panels are installed. The swelling, especially the edge swelling, may e.g., lead to a higher risk of damaging wear on the building panel, especially if the building panel is a floor panel.

### SUMMARY

An object of at least embodiments of the present disclosure is to provide improvements over known art. This object may be achieved by a technique defined in the appended independent claims; certain embodiment being set forth in the related dependent claims.

Another object of at least embodiments of the present disclosure is to decrease the production time and increase the production efficiency of producing a building panel.

Another object of at least embodiments of the present disclosure is to provide a building panel with improved sound-attenuating properties.

Yet another object of at least embodiments of the present invention is to provide a building panel with insulating properties, for example thermally insulating properties.

A further object of at least embodiments of the present disclosure is to provide a building panel having a soft touch.

Yet another object of at least embodiments of the present disclosure is to increase the water resistance of a building panel comprising lignocellulosic particles.

Another object of at least embodiments of present disclosure is to be able to adapt and control features of the building panel without any additional preprocessing of the components of the building panel.

A further object of at least embodiments of the disclosure is to increase the control and the adaptability of the structure of the building panel in order to be combined with different types of mechanical locking devices.

Another object of at least embodiments of the present disclosure is to achieve a beneficial balance between good water resistant or water repellent properties in a building panel and a good production economy when producing the building panel.

Yet another object of at least embodiments of the present disclosure is to lower the amount of added binder when producing a building panel, while still keeping good water resistant or water repellent properties in the building panel.

A further object of at least embodiments of the present disclosure is to produce a building panel with a better environmental profile compared to known building panels.

Yet another object of at least embodiments of the present disclosure is to produce a building panel with a lower carbon footprint compared to known building panels.

In a first aspect there is provided a method of producing a building panel, such as a floor panel, a wall panel, or a furniture component, comprising:
applying a back side layer comprising a first mixture of at least lignocellulosic particles and a binder,
applying an intermediate layer comprising a second mixture of at least lignocellulosic particles and a binder, on the back side layer,
applying a front side layer comprising a third mixture of at least lignocellulosic particles and a binder, on the intermediate layer,
applying a front cork layer by applying cork particles on the front side layer prior to applying pressure and heat, and
applying pressure and heat to the back side layer, the intermediate layer, the front side layer, and the front cork layer, thereby forming the building panel.

In an embodiment, an average particle size of the lignocellulosic particles in the second mixture is greater than an average particle size of the lignocellulosic particles in the first and/or third mixture. This can advantageously reduce and/or provide more controlled flexing and/or swelling. As will be further described herein, this can in turn provide increased water resistant properties and reduce the risk of fluid penetrating into the building panel.

For example, an average particle size of the lignocellulosic particles in the second mixture may be at least 25 percentage greater than an average particle size of the lignocellulosic particles in the first and/or third mixture, such as at least 40 percentage greater, or such as at least 50 percentage greater.

In an embodiment, an average particle size of the lignocellulosic particles in the first mixture is between 0.3 mm and 1.25 mm, such as between 0.3 and 0.6 mm.

In an embodiment, an average particle size of the lignocellulosic particles in the second mixture is between 0.5 and 4 mm, such as between 0.5 and 2.5 mm, such as between 0.5 and 1.5 mm or such as between 0.6 and 1.3 mm.

In an embodiment, an average particle size of the lignocellulosic particles in the third mixture is between 0.3 mm and 1.25 mm, such as between 0.3 and 0.6 mm.

Average particle size may be determined by a conventional vibratory sieving analysis, using a vibratory sieve shaker.

In an embodiment, at least 50% of the lignocellulosic particles in the second mixture has an aspect ratio of between 1:1 and 30:1.

The aspect ratio is here, and throughout this disclosure, the ratio between the length and the width of the fibres.

Establishing the aspect ratio may for the embodiments in this disclosure be made by, e.g., optical means, by photographing the fibres and digitally measure them. Other suitable means and methods may be used to establish the aspect ratio.

An advantage of at least embodiments of the building panel manufactured according to the method as presented above, compared to a standard particle board, may be that the density of the building panel may be controlled. The density of the layers may be adapted to different kinds of mechanical locking devices arranged in the building panel, where the mechanical locking devices may be one way of increasing the water resistance of a building panel. The density of the layers may be adapted to the intended use of the building panel.

Another advantage of at least embodiments of the obtained building panel, this time compared to a standard fibre board, may be that the building panel, if fluid penetrates the building panel and the building panel partly swells due to the fluid, the swelling will withdraw compared to a fibre board where a swelling will lead to a permanent shape change in the board.

Another advantage of at least embodiments of the disclosed method is that cork particles can be bonded to each other, and to the front side layer, without adding any additional binder to the cork particles. The cork particles are bonded to each other to form the front cork layer, at least partly, by natural resins of the cork particles, such as suberin and lignin, when heat and pressure is applied to the cork particles. The cork particles may be bonded to the front side layer at least partly by the binder of the front side layer. In a border area between the front cork layer and the front side layer, the binder of the front side layer may permeate into the cork layer.

The front cork layer may provide the building panel with sound-attenuating properties.

The front cork layer may further provide the building panel with insulating properties. Insulating properties may for example be thermally insulating properties.

The front cork layer may provide the building panel with a soft touch. A soft touch may be described as a soft, pleasant experience when touched by a consumer. For example, a floor panel with a soft touch may be experienced by a consumer to be soft and pleasant to walk on.

The front cork layer may provide the building panel with a surface layer, such that no additional decorative layer has to be applied. The front cork layer may provide the building panel with a natural appearance.

In an embodiment, after applying pressure and heat, a surface of the front cork layer opposite the front side layer may be substantially free from added binder.

In an embodiment, after applying pressure and heat, a surface of the front cork layer opposite the front side layer may be substantially free from added binder from the third mixture. By being substantially free from added binder may imply free from any binder not naturally occurring in the cork particles. By the surface of the front cork layer being free from added binder may comprise that at least 80% of the surface may be free from added binder, such as at least 90% of the surface may be free from added binder. In one embodiment the surface of the front cork layer may be free from added binder.

By added binder is understood to mean binder not being naturally occurring in the cork particles in the present disclosure.

In an embodiment, the cork particles may be applied on the front side layer as granulated cork material. Throughout the present disclosure, granulated cork material refers to a material made by grinding or chopping natural cork into small particles or granules. The cork particles may be applied as loose particles. Loose particles may be not coherent.

In an embodiment, the cork particles may be applied on the front side layer without adding any binder. The cork particles may comprise natural resins, such as suberin and lignin, but no additional binder may be added to the cork particles.

In an embodiment, the cork particles may be applied on the front side layer without adding any binder as a layer between the front cork layer and the front side layer or as part of the cork layer.

In an embodiment, the front cork layer may consist of the cork particles prior to applying pressure and heat.

In an embodiment, the front cork layer may be attached to the front side layer by the binder of the third mixture.

In an embodiment, the cork particles may be bonded to each other when pressure and heat is applied at least partly by natural resins of the cork particles.

In an embodiment, the cork particles may be bonded to each other when pressure and heat is applied at least partly by the binder of the third mixture.

In an embodiment, the cork particles may be bonded to the front side layer at least partly by the binder of the third mixture.

In an embodiment, a thickness of the front cork layer may be 0.5-1 mm after applying pressure and heat.

In an embodiment, the method may further comprise applying a front side element on the front cork layer prior to applying pressure and heat, wherein the front side element is configured to be attached to the front cork layer when pressure and heat is applied to form the building panel. In an embodiment, the front side element may be chosen from a group consisting of: a wood veneer element, a paper sheet, a resin impregnated paper sheet, a polymer-based sheet, a prefabricated powder-based sheet, or a powder layer comprising wood fibres and binder.

In an embodiment, the front cork layer may be configured to penetrate into open features, such as cracks, holes, or pores, of the wood veneer and at least partly fill such open features when pressure and heat is applied.

In an embodiment, the method may further comprise applying a back cork layer by applying cork particles on a carrier, and applying the back side layer on the back cork layer.

In an embodiment, the cork particles may be applied on the carrier as granulated cork material.

In an embodiment the method may further comprise providing a back side element on which the back cork layer is applied prior to applying pressure and heat to form said building panel, wherein the back cork layer is configured to attach to the back side element when pressure and heat is applied to form said building panel.

The back side element may be chosen from a group consisting of a paper sheet, a resin impregnated paper sheet, a wood veneer element, a polymer-based sheet, a prefabricated powder-based sheet, or a powder layer comprising wood fibres and binder.

In an alternative embodiment, the method may comprise applying a front side element on the front cork layer and/or applying a back side element on the back cork layer after the building panel has been formed, i.e., after pressure and heat has been applied to form the building panel. After heat and pressure has been applied to the building panel, the building panel may be transported to another location, such as to another production facility, where a front side element and/or a back side element is applied. Applying the front side element on the front cork layer and/or applying the back side element on the back cork layer after the building panel has been formed may for example comprise attaching the front side element and/or back side element by gluing or by applying heat and pressure to the building panel again.

In an embodiment the building panel may be a floor panel, a wall panel, or a furniture component. Examples of a furniture component are a cabinet panel, a drawer panel, or a countertop panel.

In a second aspect of the disclosure there is provided a building panel such as a floor panel, a wall panel or a furniture component, comprising a multi-layered substrate comprising a back side layer comprising lignocellulosic particles and a binder, an intermediate layer comprising lignocellulosic particles and a binder, arranged on the back side layer, a front side layer comprising lignocellulosic particles and a binder, arranged on the intermediate layer, and a front cork layer comprising cork particles, arranged on the front side layer.

A surface of the front cork layer opposite the front side layer may be substantially free from added binder. A surface of the front cork layer opposite the front side layer may be substantially free from added binder from the front side layer. By being substantially free from added binder may imply free from any binder not naturally occurring in the cork particles. By the surface of the front cork layer being free from added binder may comprise that at least 80% of the surface may be free from added binder, such as at least 90% of the surface may be free from added binder. In one embodiment the surface of the front cork layer may be free from added binder.

By added binder is understood to mean binder not being naturally occurring in the cork particles in the present disclosure.

In an embodiment, the average particle size of the lignocellulosic particles in the intermediate layer may be greater than an average particle size of the lignocellulosic particles in the back side layer and/or the front side layer.

For example, an average particle size of the lignocellulosic particles in the intermediate layer may be at least 40 percentage greater than an average particle size of the lignocellulosic particles in the back side layer and/or the front side layer, such as at least 50 percentage greater, or at least 50 percentage greater.

In an embodiment, an average particle size of the lignocellulosic particles in the back side layer is between 0.3 mm and 1.25 mm, such as between 0.3 and 0.6 mm.

In an embodiment, an average particle size of the lignocellulosic particles in the intermediate layer is between 0.5 and 4 mm, such as between 0.5 and 2.5 mm, such as between 0.5 and 1.5 mm or such as between 0.6 and 1.3 mm.

In an embodiment, an average particle size of the lignocellulosic particles in the front side layer is between 0.3 mm and 1.25 mm, such as between 0.3 and 0.6 mm.

Average particle size may be determined by a conventional vibratory sieving analysis, using a vibratory sieve shaker.

In an embodiment, at least 50 wt % of the lignocellulosic particles of the intermediate layer may have an aspect ratio of between 1:1 and 30:1.

The aspect ratio is here, and throughout this disclosure, the ratio between the length and the width of the fibres.

An advantage with the building panel presented above, compared to a standard particle board, is that the density of the building panel can be controlled. The density of the different layers may be adapted to different kinds of mechanical locking devices arranged in the building panel, where the mechanical locking devices may be one way of increasing the water resistance of a building panel. The density of the different layers may be adapted to the intended use of the building panel.

Another advantage with the building panel, this time compared to a standard fibre board, is that the building panel, even if fluid penetrates the building panel and the building panel partly swells due to the fluid, the swelling will withdraw compared to a fibre board where a swelling will lead to a permanent shape change in the board.

The front cork layer may provide the building panel with sound-attenuating properties.

The front cork layer may further provide the building panel with insulating properties, for example thermally insulating properties.

The front cork layer may provide the building panel with a surface layer, such that no additional decorative layer has to be applied. The front cork layer may provide the building panel with a natural appearance.

In one embodiment, the back side layer may be formed from a first mixture of the lignocellulosic particles and the binder, the intermediate layer is formed from a second mixture of the lignocellulosic particles and the binder, and the front side layer is formed from a third mixture of the lignocellulosic particles and the binder.

In an embodiment, the cork particles may comprise granulated cork material.

In an embodiment, the front cork layer may be attached to the front side layer by the binder of the third mixture.

In an embodiment, the cork particles may be bonded to each other at least partly by natural resins of the cork particles.

In an embodiment, the cork particles may be bonded to each other at least partly by the binder of the front side layer.

In an embodiment, the cork particles may be bonded to the front side layer at least partly by the binder of the front side layer.

In an embodiment, a thickness of the front cork layer may be 0.5-1 mm.

In an embodiment, the building panel may further comprise a front side element attached to the front cork layer.

In an embodiment, the front side element may be chosen from a group consisting of: a wood veneer element, a paper sheet, a resin impregnated paper sheet, a polymer-based sheet, a prefabricated powder-based sheet, or a powder layer comprising wood fibres and binder.

In an embodiment, the building panel may further comprise a back cork layer comprising cork particles, arranged on the back side layer, wherein a surface of the back cork layer, opposite the back side layer is free from added binder.

In an embodiment the building panel may further comprise a back side element attached to the back cork layer of the multi-layered substrate.

The back side element may be chosen from a group consisting of a paper sheet, a resin impregnated paper sheet, a wood veneer element, a polymer-based sheet, a prefabricated powder-based sheet, or a powder layer comprising wood fibres and binder.

In an embodiment, the building panel may be a floor panel, a wall panel, or a furniture component. Examples of a furniture component may be a cabinet panel, a drawer panel, or a countertop panel.

### BRIEF DESCRIPTION OF THE DRAWINGS

Embodiments of the disclosure will be described in the following: reference being made to the appended drawings which illustrate non-limiting embodiments of how the disclosure can be reduced into practice.

FIG. 1 is a schematic illustration of a method to produce a building panel according to an embodiment of the present disclosure,

FIG. 2 is a schematic illustration of a method to produce a building panel according to another embodiment of the present disclosure,

FIG. 3A is a schematic illustration of a continuation of the methods illustrated in FIGS. 1 and 2, according to an embodiment of the present disclosure,

FIG. 3B is a schematic illustration of another continuation of the methods illustrated in FIGS. 1 and 2, according to an embodiment of the present disclosure,

FIG. 4 is a schematic illustration of a method to produce a building panel according to an embodiment of the present disclosure,

FIG. 5 is a schematic illustration of a method to produce a building panel according to an embodiment of the present disclosure,

FIG. 6 is a schematic illustration of a method to produce a building panel according to an embodiment of the present disclosure,

FIG. 7 is a schematic illustration of a method to produce a building panel according to an embodiment of the present disclosure,

FIG. 8A is an illustration of a cross section through layers in a building panel, according to an embodiment of the present disclosure,

FIG. 8B is an illustration of a cross section through layers in a building panel, according to an embodiment of the present disclosure,

FIG. 8C is an illustration of a cross section through layers in a building panel, according to an embodiment of the present disclosure,

FIG. 9 is an illustration of a cross-section through a building panel with open features, according to an embodiment of the present disclosure,

FIG. 10 is an illustration of a top view of a building panel with a mechanical locking device, according to an embodiment of the present disclosure,

FIG. 11A is an illustration of an assembly of three substantially identical building panels, according to an embodiment of the present disclosure,

FIG. 11B is an illustration of the three building panels in FIG. 11A in an assembled state,

FIG. 12A is an illustration of a cross section of a mechanical locking device according to an embodiment of the present disclosure, in an assembled state arranged along opposite edges of two adjacent building panels,

FIG. 12B is an illustration of a cross section of a mechanical locking device according to another embodiment of the present disclosure, in an assembled state arranged along opposite edges of two adjacent building panels,

FIG. 13 is an illustration of a top view of a displaceable locking tongue according to an embodiment of the present disclosure, for a mechanical locking device,

FIG. 14A is an illustration of a cross section of a building panel according to another embodiment of the present disclosure, in an assembled state arranged along opposite edges of two adjacent panels,

FIG. 14B is an illustration of a cross section of a building panel according to yet another embodiment of the present disclosure, in an assembled state arranged along opposite edges of two adjacent panels,

### DETAILED DESCRIPTION OF EMBODIMENTS

Specific embodiments of the disclosure will now be described with reference to the accompanying drawings. The disclosure may, however, be embodied in many different forms and should not be construed as limited to the embodiments set forth herein; rather, these embodiments are provided so that this disclosure will be thorough and complete, and will fully convey the scope of the disclosure to those skilled in the art. The terminology used in the detailed description of the embodiments illustrated in the accompanying drawings is not intended to be limiting of the disclosure. In the drawings, like numbers refer to like elements.

Generally, in this disclosure, terms like “below” or “lower” typically implies closer to the back surface of the panel or a plane thereof, whereas “above” or “upper” implies closer to the front surface or a plane thereof. The terms “front side” and “back side” imply, respectively, on which side of a centre axis, usually a horizontal centre axis, the feature is arranged. Further, the thickness direction of the panel is defined as the vertical direction when the panel lays flat on a surface. The horizontal and vertical direction are applicable definition when the building panel is lays flat on e.g., a floor. Instead of horizontal and vertical directions, the description will also refer to a direction parallel with extension of the top or uppermost surface and a direction perpendicular to the extension of the top or uppermost surface. When a building panel is lays flat on e.g., a floor, the horizontal direction is the same as the direction parallel with the extension of the top or uppermost surface and the vertical direction is the same as the direction perpendicular to the extension of the top or uppermost surface.

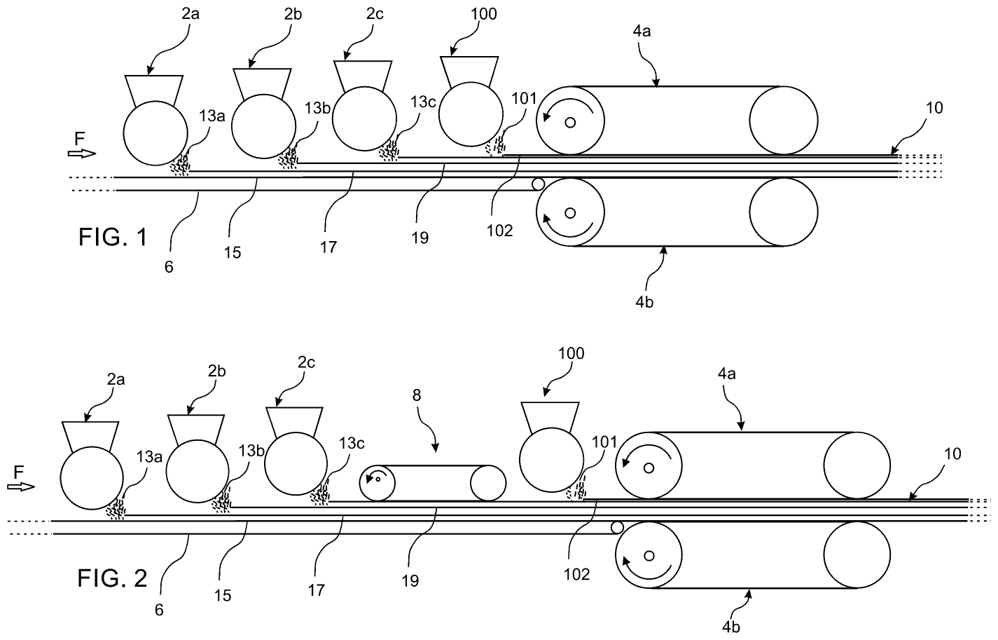

FIGS. 1-7 illustrate different setup possibilities and methods for producing a building panel in accordance with the disclosure. Such a panel may be used as a floor panel, a wall panel, a ceiling panel, or furniture components, e.g., cabinet panels, drawer panels, or countertop panels.

The building panel manufactured by any of the methods illustrated in FIGS. 1-7 may either be a building panels which is ready to be used as it is, or be provided with a suitable wear layer, such as a lacquer, a coating, an overlay sheet, or any other layer comprising e.g., wear resistant particles, such as aluminium oxide particles, and/or scratch resistant particles, either before pressure and heat is applied or after the building panel has been formed. In alternative embodiments, the building panel may subsequently be provided with, e.g., a front side element, preferably decorative, such as a paper sheet, a resin impregnated paper sheet, a polymer-based sheet, a prefabricated powder-based sheet, or a wood veneer element. Such a surface layer may subsequently be e.g., glued and/or pressed on to the panel. Further, the front side element may be combined with a suitable wear layer, such as a lacquer, an overlay sheet, or any other layer comprising e.g., wear resistant particles, such as aluminium oxide particles, and/or scratch resistant particles, either before pressure and heat is applied or after the building panel has been formed.

Alternatively, the building panel may subsequently be painted to achieve a preferred décor of the panel. Yet further, the building panel may subsequently be provided with, e.g., a back side element, such as a paper sheet, a resin impregnated paper sheet, a wood veneer element, a polymer-based sheet, a prefabricated powder-based sheet, or a powder layer comprising wood fibres and binder. Such a back side element may subsequently be e.g., glued and/or pressed on to the panel.

After heat and pressure has been applied to form the building panel, the building panel may be transported to another location, such as to another production facility, where a front side element and/or a back side element is applied.

A front side element of the building panel may comprise a thermoset resin, for example an amino resin such as melamine formaldehyde, urea formaldehyde, phenol formaldehyde resins, or combinations thereof, or no-added formaldehyde resins such as epoxy resins, acrylic resins, polyurethane resins, polymeric diphenylmethane diisocyanate resin, polyester resins, or combinations thereof.

A front side element of the building panel may comprise thermoplastic materials, such as polyvinyl chloride (PVC), polyvinyl butyral (PVB), polyethylene (PE), polypropylene (PP), thermoplastic polyurethane (TPU), acrylonitrile butadiene styrene (ABS), polystyrene (PS), polyethylene terephthalate (PET), polyethylene terephthalate glycol (PETG), polyethersulfone (PES), or combinations thereof.

A back side element of the building panel may comprise a thermoset resin, for example an amino resin such as melamine formaldehyde, urea formaldehyde, phenol formaldehyde resins, or combinations thereof, or no-added formaldehyde resins such as epoxy resins, acrylic resins, polyurethane resins, polymeric diphenylmethane diisocyanate resin, polyester resins, or combinations thereof.

A back side element of the building panel may comprise thermoplastic materials, such as polyvinyl chloride (PVC), polyvinyl butyral (PVB), polyethylene (PE), polypropylene (PP), thermoplastic polyurethane (TPU), acrylonitrile butadiene styrene (ABS), polystyrene (PS), polyethylene terephthalate (PET), polyethylene terephthalate glycol (PETG), polyethersulfone (PES), or combinations thereof.

The building panel manufactured by any of the methods illustrated in FIGS. 5-7 is a building panel which is provided with a front side element and/or a back side element already in the manufacturing method. Such a front side element and/or back side element may be a paper sheet, a resin impregnated paper sheet, a polymer-based sheet, a prefabricated powder-based sheet, a powder layer, or a wood veneer element.

However, several features in the production setups are the same. For example, each setup has three applicator devices 2a, 2b, 2c which are configured to each apply a mixture 13a, 13b, 13c. The applicator devices 2a, 2b, 2c may scatter the mixtures or roll on the mixtures, i.e., may work either at a distance from where the mixtures are applied or be in contact with where the mixtures are applied. The applicator devices 2a, 2b, 2c may further be configured to handle mixtures of any form, i.e., mixtures in, e.g., dry form or wet form.

Each setup further has at least one building panel forming device 4a, 4b which is configured to apply both heat and pressure to form a building panel. In the illustrated example there is illustrated two opposite building panel forming devices 4a, 4b where one is arranged on the front side and the other is arranged on the back side. Both may be configured to apply both pressure and heat, but it is also possible that there is a difference between the two building panel forming devices 4a, 4b, e.g., one may be configured to apply both heat and pressure while the other is only configured to apply pressure. In the illustrated example the building panel forming devices 4a, 4b are continuous devices working in the feeding direction F. In another embodiment (not illustrated) the building panel forming devices may be discontinuous devices, such as a static device.

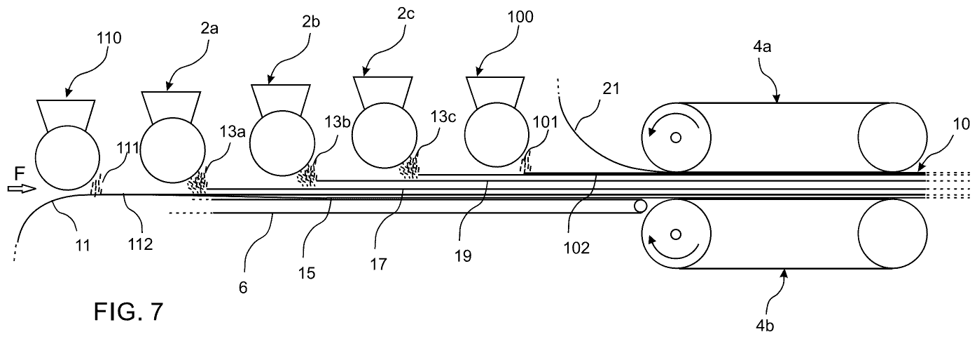

The first applicator device 2a is configured to apply a first mixture 13a to form a back side layer 15 of a building panel 10. In FIGS. 1, 2, 4, 5 and 6 the first mixture 13a is applied onto a carrier 6, such as a carrier belt or a conveyor belt or the like, whereas in FIG. 7 the first mixture 13a is applied onto a back cork layer 112. In alternative embodiment, the carrier 6 may be a film.

The first mixture 13a may be applied in dry form or wet form and may in an embodiment be a powder. For example, the mixture(s) may be in dry form, such as in powder form. For example, the mixture(s) may be in wet form, such as in a mixture with water or other liquid.

The resulting back side layer 15 of the applied and subsequently pressed first mixture 13a preferably has a thickness in the direction perpendicular to the longitudinal extension of a top surface 24 of the building panel 10 which may be between 2 mm and 3 mm of a building panel 10 with the total thickness of about 10 mm. The resulting back side layer 15 of the applied and subsequently pressed first mixture 13a preferably has a thickness in the direction perpendicular to the longitudinal extension of a top surface 24 of the building panel 10 which is between 20% and 30% of the total thickness of the building panel 10.

The first mixture 13a includes at least lignocellulosic particles and a binder.

The lignocellulosic particles in the first mixture 13a may be wood particles, e.g., made of pine, oak, eucalyptus, or other wood species, straws from grain products, sisal, coconut, bamboo, hemp, flax, jute, curaua, ramie, or any combination of such particles. The lignocellulosic particles make up between 70 wt. % and 99 wt. %, above 75 wt. % or above 85 wt. % of the first mixture 13a.

The majority, i.e., at least 50 wt. %, of the lignocellulosic particles in the first mixture 13a has a particle size of between 0.3 mm and 0.6 mm. Preferably at least 60 wt. %, at least 70 wt. %, or at least 80 wt. % of the lignocellulosic particles in the first mixture 13a have a particle size of between 0.3 mm and 0.6 mm. In an alternative embodiment, the majority, i.e., at least 50 wt. %, of the lignocellulosic particles in the first mixture 13a has a particle size of between 0.3 mm and 1.25 mm. Preferably at least 60 wt. %, at least 70 wt. %, or at least 80 wt. % of the lignocellulosic particles in the first mixture 13a have a particle size of between 0.3 mm and 1.25 mm.

In an embodiment, an average particle size of the lignocellulosic particles in the first mixture 13a is between 0.3 mm and 1.25 mm, such as between 0.3 and 0.6 mm.

Average particle size and particle size may be determined by conventional vibratory sieving analysis, using a vibratory sieve shaker. A method referring to sieving analysis is described in DIN 66165. In the present disclosure, average particle size and particle size have been determined by a Fritsch Analysette 3 Pro. Average particle size may be determined as the median value of the particle size interval of the size class with the highest weight proportion in a sieving analysis. A size class in a sieving analysis may be the size interval ranging from the aperture size of the sieving net that the particles did not fall through until the aperture size of the sieving net that the particles fell through. A size class may for example be from 0.5 mm to 1 mm, or from 0.3 mm to 0.4 mm.

The lignocellulosic particles in the first mixture 13a can also be measured by an aspect ratio, i.e., the ratio between the length of the particle and its width. The aspect ratio of the majority, i.e., at least 50%, of the lignocellulosic particles in the first mixture 13a is below 30. Preferably at least 60%, at least 70%, or at least 80% of the lignocellulosic particles in the first mixture 13a have an aspect ratio below 30. The aspect ratio of the majority, i.e., at least 50%, of the lignocellulosic particles in the first mixture 13a is between 1:1 and 30:1, between 1:1 and 20:1 or between 1:1 and 10:1. Preferably the aspect ratio of at least 60%, at least 70%, or at least 70% or at least 80% of the lignocellulosic particles in the first mixture 13a is between 1:1 and 30:1, between 1:1 and 20:1, or between 1:1 and 10:1. In an embodiment the particle size of the lignocellulosic particles in the first mixture 13a is between 0.3 mm and 1.25 mm, or between 0.3 mm and 0.6 mm and with an aspect ratio less than 20 or less than 10.

Establishing the aspect ratio may for the embodiments in this disclosure be made by, e.g., optical means, by photographing the fibres and digitally measure them. Other suitable means and methods may be used to establish the aspect ratio.

The percentage of lignocellulosic particles when referring to aspect ratio in the present disclosure is calculated by calculating the number of particles having the specified aspect ratio.

The binder in the first mixture 13a may be a thermoset resin. Examples of suitable thermoset resins are amino resins such as melamine formaldehyde, urea formaldehyde, phenol formaldehyde resins, or combinations thereof, or no-added formaldehyde resins such as epoxy resins, acrylic resins, polyurethane resins, polymeric diphenylmethane diisocyanate resin, polyester resins, or combinations thereof.

The binder makes up between 5 wt. % and 35 wt. %, or between 10 and 25 wt. % of the first mixture 13a. As common in wood industry, and described above the amounts are calculated on dry weight, with the amount of bone-dry wood=100% as base.

The amount of binder in the first mixture 13a, or in any of the mixtures 13b, 13c in this disclosure, may affect the water resistant or water repellent properties of the layers 15, 17, 19 of the building panel 10 which are formed from respective mixture 13a, 13b, 13c. Having more binder in the mixture 13a, 13b, 13c will increase the water resistant or water repellent properties in the building panel 10. However, binder is also the more expensive component of the mixture, thus, an amount as defined above gives a beneficial balance between effect and cost.

The first mixture 13a may further include hydrophobing agent, such as wax. The first mixture 13a may comprise 1-3 wt. %, or 1-2 wt. % of the hydrophobing agent. Preferred hydrophobing agents are paraffin emulsions. An advantage with having a hydrophobing agent in the first mixture 13a, and in any of the mixtures 13b, 13c in this disclosure, is that it provides the layers 15, 17, 19 of the building panel 10 which are formed from respective mixture 13a, 13b, 13c with improved water repellent properties, in turn creating a more water resistant building panel 10. It may thus be beneficial to add a hydrophobing agent in the mixture 13a, 13b, 13c forming a layer 15, 17, 19 in which features for increasing the water resistant properties of the building panel 10 are created. Examples of this will be described later on.

The first mixture 13a may further comprise different types of additives, such as colorant, catalyst (e.g., ammonium sulphate), formaldehyde scavenger (e.g., urea), or buffer solution.

The second applicator device 2b is configured to apply a second mixture 13b to form an intermediate layer 17 of the building panel 10. In FIGS. 1-2 and 4-7 the second mixture 13b is applied onto the first mixture 13a. As the second mixture 13b is applied onto the first mixture 13a, particles, in particular lignocellulosic particles, from each of the back side layer 15 and the intermediate layer 17 will mix, at least in a border area between the back side layer 15 and the intermediate layer 17.

The second mixture 13b may be applied in dry form or wet form and may in an embodiment be a powder. For example, the mixture(s) may be in dry form, such as in powder form. For example, the mixture(s) may be in wet form, such as in a mixture with water or other liquid.

The resulting intermediate layer 17 of the applied and subsequently pressed second mixture 13b preferably has a thickness in the direction perpendicular to the extension of the top surface 24 of the building panel 10 which is between 0.9 mm and 19.6 mm of a building panel 10, resulting in a building panel with the total thickness of between 4 mm and 28 mm. In an embodiment, the resulting intermediate layer 17 of the applied and subsequently pressed second mixture 13b preferably has a thickness in the direction perpendicular to the extension of a top surface 24 of the panel 10 which is between 3 mm and 7 mm of a panel 10, resulting in a panel with the total thickness of about 10 mm. The resulting intermediate layer 17 of the applied and subsequently pressed second mixture 13b preferably has a thickness in the direction perpendicular to the longitudinal extension of the top surface 24 of the building panel 10 which is between 30% and 70% of the total thickness of the building panel 10.

The second mixture 13b includes at least lignocellulosic particles and a binder.

The lignocellulosic particles in the second mixture 13b may be wood particles, e.g., made of pine, oak, eucalyptus, or other wood species, straws from grain products, sisal, coconut, bamboo, hemp, flax, jute, curaua, ramie, or any combination of such particles. The lignocellulosic particles make up between 70 wt. % and 99 wt. %, above 75 wt. % or above 85 wt. % of the second mixture 13b.

The majority, i.e., at least 50 wt. %, of the lignocellulosic particles in the second mixture 13b has a particle size of between 0.5 mm and 4 mm, or between 0.5 mm and 2.5 mm, or between 0.5 mm and 1.5 mm, or between 0.6 mm and 1.3 mm. Preferably at least 60 wt. %, at least 70 wt. % or at least 80 wt. % of the lignocellulosic particles in the second mixture 13b have a particle size of between 0.5 mm and 4 mm, or between 0.5 mm and 2.5 mm, or between 0.5 mm and 1.5 mm, or between 0.6 mm and 1.3 mm.

In an embodiment, an average particle size of the lignocellulosic particles in the second mixture 13b is between 0.5 and 4 mm, such as between 0.5 and 2.5 mm, such as between 0.5 and 1.5 mm or such as between 0.6 and 1.3 mm.

The lignocellulosic particles in the second mixture 13b can, like explained for the first mixture, also be measured by an aspect ratio, i.e., the ratio between the length of the particle and its width. The aspect ratio of the majority, i.e., at least 50%, of the lignocellulosic particles in the second mixture 13b is below 30. Preferably at least 60%, at least 70%, or at least 80% of the lignocellulosic particles in the second mixture 13b have an aspect ratio below 30. The aspect ratio of the majority, i.e., at least 50%, of the lignocellulosic particles in the second mixture 13b is between 1:1 and 30:1, between 1:1 and 20:1, or between 1:1 and 10:1. Preferably the aspect ratio of at least 60%, at least 70%, or at least 80% of the lignocellulosic particles in the second mixture 13b is between 1:1 and 30:1, between 1:1 and 20:1, or between 1:1 and 10:1. In an embodiment the particle size of the lignocellulosic particles in the second mixture 13b is between 0.6 mm and 1.3 mm and with an aspect ratio less than 10. In another embodiment the particle size of the lignocellulosic particles in the second mixture 13b is between 0.6 mm and 4 mm and with an aspect ratio less than 10.

The binder in the second mixture 13b may be a thermoset resin. Examples of suitable thermoset resins are amino resins such as melamine formaldehyde, urea formaldehyde, phenol formaldehyde resins, or combinations thereof, or no-added formaldehyde resins such as epoxy resins, acrylic resins, polyurethane resins, polymeric diphenylmethane diisocyanate resin, polyester resins, or combinations thereof. The binder in the second mixture 13b may be the same binder as in the first mixture 13a.

The binder makes up between 3 wt. % and 20 wt. %, or between 5 wt. % and 10 wt. % of the second mixture 13b.

The amount of binder in the second mixture 13b, or in any of the mixtures 13a, 13c in this disclosure, may affect the water resistant or water repellent properties of the layers 15, 17, 19 of the building panel 10 which are formed from respective mixture 13a, 13b, 13c. Having more binder in the mixture 13a, 13b, 13c will increase the water resistant or water repellent properties in the building panel 10. However, binder is also the more expensive component of the mixture, thus, an amount as defined above gives a beneficial balance between effect and cost.

The second mixture 13b may further include hydrophobing agent, such as wax. The second mixture 13b may comprise 1-3 wt. %, or 1-2 wt. % of the hydrophobing agent. Preferred hydrophobing agents are paraffin emulsions. An advantage with having a hydrophobing agent in the second mixture 13b, and in any of the mixtures 13a, 13c in this disclosure, is that it provides the layers 15, 17, 19 of the building panel 10 which are formed from respective mixture 13a, 13b, 13c with improved water repellent properties, in turn creating a more water resistant building panel 10. It may thus be beneficial to add a hydrophobing agent in the mixture 13a, 13b, 13c forming a layer 15, 17, 19 in which features for increasing the water resistant properties of the building panel 10 are created. Examples of this will be described later on.

The second mixture 13b may further comprise different types of additives, such as colorant, catalyst (e.g., ammonium sulphate), formaldehyde scavenger (e.g., urea), or buffer solution.

The third applicator device 2c is configured to apply a third mixture 13c to form a front side layer 19 of the building panel 10. In FIGS. 1-2 and 4-7 the third mixture 13c is applied onto the second mixture 13b. As the third mixture 13c is applied onto the second mixture 13b, particles, in particular lignocellulosic particles, from each of the intermediate layer 17 and the front side layer 19 will mix, at least in a border area between the front side layer 19 and the intermediate layer 17.

The third mixture 13c may be applied in dry form or wet form and may in an embodiment be a powder. For example, the mixture(s) may be in dry form, such as in powder form. For example, the mixture(s) may be in wet form, such as in a mixture with water or other liquid.

The resulting front side layer 19 of the applied and subsequently pressed third mixture 13c preferably has a thickness in the direction perpendicular to the extension of a top surface 24 of the building panel 10 which is between 2 mm and 3 mm of a building panel 10 with the total thickness of about 10 mm. The resulting front side layer 19 of the applied and subsequently pressed third mixture 13c preferably has a thickness in the direction perpendicular to the longitudinal extension of the top surface 24 of the building panel 10 which is between 20% and 30% of the total thickness of the building panel 10.

The ratio between the amount of the applied third mixture 13c and the amount of the applied first mixture 13a may be between 40:60 and 60:40, or between 45:55 and 55:45. The ratio between the amount of the applied third mixture 13c and the amount of the applied first mixture 13a is about 50:50.

The ratio between the amount of the applied second mixture 13b and the total amount of the applied first and third mixture 13a, 13c is between 70:30 and 30:70, or between 60:40 and 40:60. The ratio between the amount of the applied first mixture 13a, the applied second mixture 13b and the applied third mixture 13c may be 20-60-20 wt. %, or 25-50-25 wt. % or 30-40-30 wt. %. In other examples, the ratio between the amount of the applied first mixture 13a, the applied second mixture 13b and the applied third mixture 13c may be 5-90-5 wt. %. The sum of the first mixture 13a, the second mixture 13b, and the third mixture 13c form the total amount of applied mixtures, i.e., 100 wt. %.

The third mixture 13c includes at least lignocellulosic particles and a binder.

The lignocellulosic particles in the third mixture 13c may be wood particles, e.g., made of pine, oak, eucalyptus, or other wood species, straws from grain products, sisal, coconut, bamboo, hemp, flax, jute, curaua, ramie, or any combination of such particles. The lignocellulosic particles make up between 70 wt. % and 99 wt. %, or above 75 wt. % or above 85 wt. % of the third mixture 13c.

The majority, i.e., at least 50 wt. %, of the lignocellulosic particles in the third mixture 13c has a particle size of between 0.3 mm and 0.6 mm. Preferably at least 60 wt. %, at least 70 wt. %, or at least 75 wt. %, or at least 80 wt. % of the lignocellulosic particles in the third mixture 13c have a particle size of between 0.3 mm and 0.6 mm. In an alternative embodiment, the majority, i.e., at least 50 wt. %, of the lignocellulosic particles in the third mixture 13c has a particle size of between 0.3 mm and 1.25 mm. Preferably at least 60 wt. %, at least 70 wt. %, or at least 80 wt. % of the lignocellulosic particles in the third mixture 13c have a particle size of between 0.3 mm and 1.25 mm.

In an embodiment, an average particle size of the lignocellulosic particles in the third mixture 13c is between 0.3 mm and 1.25 mm, such as between 0.3 and 0.6 mm.

The lignocellulosic particles in the third mixture 13c can, as explained above, also be measured by an aspect ratio, i.e., the ratio between the length of the particle and its width. The aspect ratio of the majority, i.e., at least 50%, of the lignocellulosic particles in the third mixture 13c is below 30. Preferably at least 60%, at least 70% or at least 80% of the lignocellulosic particles in the third mixture 13c have an aspect ratio below 30. The aspect ratio of the majority, i.e., at least 50%, of the lignocellulosic particles in the third mixture 13c is between 1:1 and 30:1, between 1:1 and 20:1, or between 1:1 and 10:1. Preferably the aspect ratio of at least 60%, at least 70%, or at least 80% of the lignocellulosic particles in the third mixture 13c is between 1:1 and 30:1, between 1:1 and 20:1 or between 1:1 and 10:1. In an embodiment the particle size of the lignocellulosic particles in the third mixture 13c is between 0.3 mm and 1.25 mm, or between 0.3 mm and 0.6 mm and with an aspect ratio less than 20 or less than 10.

The binder in the third mixture 13c may be a thermoset resin. Examples of suitable thermoset resins are amino resins such as melamine formaldehyde, urea formaldehyde, phenol formaldehyde resins, or combinations thereof, or no-added formaldehyde resins such as epoxy resins, acrylic resins, polyurethane resins, polymeric diphenylmethane diisocyanate resin, polyester resins, or combinations thereof. The binder in the third mixture 13c may be the same binder as in the first mixture 13a and/or the second mixture 13b.

The binder may make up between 5 wt. % and 35 wt. %, or between 10 wt. % and 25 wt. % of the third mixture 13c.

The amount of binder in the third mixture 13c, or in any of the mixtures 13a, 13b in this disclosure, may affect the water resistant or water repellent properties of the layers 15, 17, 19 of the building panel 10 which are formed from respective mixture 13a, 13b, 13c. Having more binder in the mixture 13a, 13b, 13c will increase the water resistant or water repellent properties in the building panel 10. However, binder is also the more expensive component of the mixture, thus, an amount as defined above gives a beneficial balance between effect and cost.

The third mixture 13c may further include hydrophobing agent, such as wax. The third mixture 13c may comprise 1-3 wt. %, or 1-2 wt. % of the hydrophobing agent. Preferred hydrophobing agents are paraffin emulsions. An advantage with having a hydrophobing agent in the third mixture 13c, and in any of the mixtures 13a, 13b in this disclosure, is that it provides the layers 15, 17, 19 of the building panel 10 which are formed from respective mixture 13a, 13b, 13c with improved water repellent properties, in turn creating a more water resistant building panel 10. It may thus be beneficial to add a hydrophobing agent in the mixture 13a, 13b, 13c forming a layer 15, 17, 19 in which features for increasing the water resistant properties of the building panel 10 are created. Examples of this will be described later on.

The third mixture 13c may further include a colorant. The colorant may be a pigment, dye, or a chemical staining agent. An example of a chemical staining agent is iron vitriol. By having a colorant in the third mixture 13c it is possible to control and adapt appearance features of the building panel 10. For example if a front side element 21, such as a front side wood veneer element, or top surface has open features 22, such as cracks, holes or the like, the colorant of the third mixture 13c is configured to colour the open features 22 as the third mixture 13c penetrates into the open features 22 and at least partly fills such open features 22 when pressure is subsequently is applied.

The third mixture 13c may yet further comprise other types of additives, such as catalyst (e.g., ammonium sulphate), formaldehyde scavenger (e.g., urea) or buffer solution.

In an embodiment the third mixture 13c may comprise wear resistant particles, such as aluminium oxide particles, or scratch resistant particles. This may be preferred if the front side layer 19, formed from the third mixture 13c, is the top layer of the building panel 10.

In order to even further increase the water resistant properties of the building panel 10 the density of each layer 15, 17, 19, formed by the mixtures 13a, 13b, 13c, may be adapted to different water resistant properties designed within the layers 15, 17, 19 of the building panel 10. For example, it may be desirable to, in the front side layer 19, design water resistant features of a mechanical locking device, which will be described in more detail below, and thus, desirable to increase the density of the front side layer 19 in order to even further improve the water resistant features of such a mechanical locking device. Whereas the intermediate layer 17 may be designed to have no additional water resistant features and therefore does not need an increased density. By adapting the density of each layer, the back side layer 15, the intermediate layer 17 and the front side layer 19 it is possible to both increase the water resistant properties of the building panel 10 where it is desirable to do so and decrease the risk of the building panel 10 becoming too heavy. The weight of the building panel 10 will also depend on the thickness of each of the components of the building panel 10 but by being able to control and adapt the thickness, the density, the lignocellulosic particle sizes, the amount of binder, etc. in each of the back side layer 15, the intermediate layer 17 and the front side layer 19 the weight of the building panel 10 also becomes controllable.

A preferred density of the intermediate layer 17 is less than the density of the front side layer 19 and/or the back side layer 15.

The density of the building panel 10 may be adapted to the intended use.

For a floor panel, a density of the intermediate layer 17 may be between 700-900 kg/m³, or about 800 kg/m³. A preferred density of the front side layer 19 may be between 800-1200 kg/m³, or between 900-1100 kg/m³. In an embodiment the density of the intermediate layer 17 may be between 900-950 kg/m³ where the total thickness of the building panel is about 10 mm.

In order to balance the building panel 10, it is preferred that the back side layer 15, even if it does not have any additional water resistant features designed in it, has the same density as the front side layer 19. Thus, the density of the back side layer 15 may be substantially the same as the density of the front side layer 19. Thus, the density of the back side layer 15 may be between 800-1200 kg/m³, or between 900-1100 kg/m³.

In total, the density of the floor panel may be 700-1100 kg/m³.

For a wall panel, a density of the intermediate layer 17 may be between 150-400 kg/m³, or about 300 kg/m³. A preferred density of the front side layer 19 may be between 400-700 kg/m³, or between 500-600 kg/m³.

In order to balance the building panel 10, it is preferred that the back side layer 15, even if it does not have any additional water resistant features designed in it, has the same density as the front side layer 19. Thus, the density of the back side layer 15 may be substantially the same as the density of the front side layer 19. Thus, the density of the back side layer 15 may be between 400-700 kg/m³, or between 500-600 kg/m³.

In total, the density of the wall panel may be 300-600 kg/m³.

As illustrated in FIGS. 1,2 and 4-7, a fourth applicator device 100 is configured to apply cork particles 101 on the front side layer 19 comprising the third mixture 13c. The cork particles 101 are configured to form a front cork layer 102 arranged on the front side layer 19.

The cork particles 101 may be applied as loose, or free, particles, The cork particles 101 may be granulated cork material. The cork particles 101 may be scattered by the fourth applicator device 100.

The cork particles 101, such as the granulated cork material, applied on the front side layer 19 may be free from added binder. The cork particles 101, such as the granulated cork material, may comprise natural resins, such as suberin and/or lignin. By free from added binder is understood free from binder not being naturally occurring in the cork particles 101, or in the cork particles 101 in form of granulated cork material. Thereby, the front cork layer 102 may consist of the cork particles 101, such as the granulated cork material, prior to applying pressure and heat.

The cork particles 101, such as the granulated cork material, may be applied on the front side layer 19 in an amount of 100-400 g/m², for example in an amount of 150-300 g/m², such as about 200 g/m². The amount of the third mixture 13c may be reduced by an amount corresponding to the amount of the cork particles 101 applied on the third mixture.

The granulated cork material may have an average particle size of 0.5-4 mm. In an embodiment, at least 90 wt %, such as at least 95 wt %, such as 100 wt. % of the granulated cork material may have a particle size of 0.5-4 mm. At least 80 wt. % of the granulated cork material may have a particle size of 1-3 mm.

After pressure and heat has been applied to the front cork layer 102, the front cork layer 102 may have a thickness of 0.5-1 mm. As previously described, pressure and heat are applied to the multi-layered substrate, comprising at least the back side layer 15, the intermediate layer 17, the front side layer 19, and the front cork layer 102, for example by the heat and pressure devices 4a, 4b previously described, also referred to as panel forming devices 4a, 4b.

When applying pressure and heat, the front cork layer 102 is bonded at least to the front side layer 19 at least partly by the binder of the third mixture 13c. During applying pressure and heat, the binder originating from the third mixture 13c may permeate into the front cork layer 102, thereby bonding the front cork layer 102 to the front side layer 19.

When applying pressure and heat, the cork particles 101, such in form of the granulated cork material, are bonded to each other at least partly by natural resins of the cork material. Natural resins may be suberin and lignin.

Further, the cork particles 101, such in form of the granulated cork material, may at least partly bond to each other by the binder of the third mixture 13c. At least cork particles 101 located adjacent the front side layer 19 may at least partly bond to each other by the binder of the third mixture 13c. During applying pressure and heat, the binder originating from the third mixture 13c may permeate into a portion of the front cork layer 102, thereby bonding cork particles and/or bonding the front cork layer 102 to the front side layer 19.

However, after pressure and heat have been applied to the multi-layered substrate, a surface of the front cork layer 102 opposite the front side layer 19 may be at least substantially free from added binder. By being substantially free from added binder may imply free from any binder not naturally occurring in the cork particles 101. By the surface of the front cork layer 102 being free from added binder may comprise that at least 80% of the surface may be free from added binder, such as at least 90% of the surface may be free from added binder. In one embodiment the front cork layer may be free from added binder. Free from added binder may mean free from a binder of a lower layer, such as the front side layer 19, and free from any binder being added between the front cork layer 102 and the front side layer 19, and free from a binder being added with the cork particles 101.

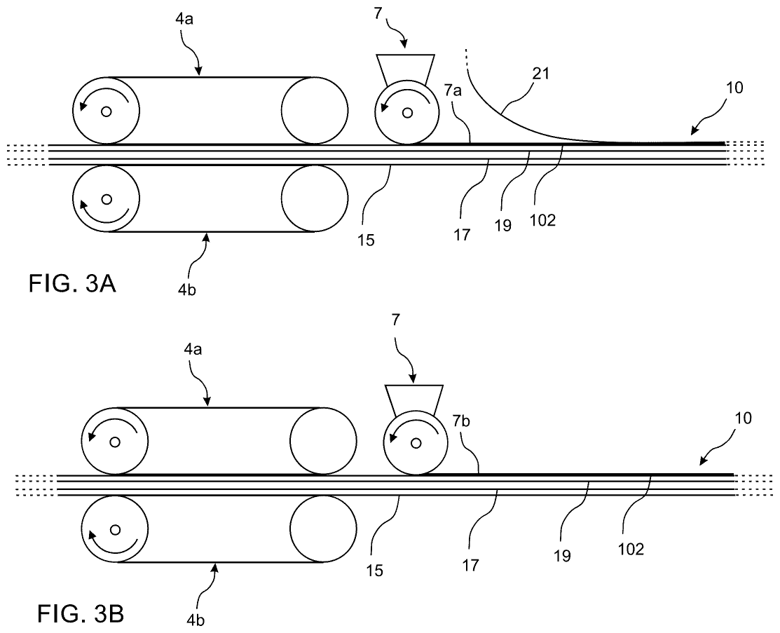

By the surface of the front cork layer 102 opposite the front side layer 19 being at least substantially free from added binder, application of a coating 7b such as a lacquer is facilitated. Adherence of the coating of the front cork layer 102 may be improved by the surface of the front cork layer 102 being at least substantially free from added binder. A further process step of applying a coating 7b is illustrated in FIG. 3B.

The front cork layer 102 may be configured to form a surface layer of the building panel 10, optionally with a coating and/or a wear resistant layer such as an overlay. In other embodiments, the front cork layer 102 may be provided with a front side element 21, either after applying pressure and heat as illustrated in FIG. 3A, or before applying pressure and heat as illustrated in FIGS. 5-7.

In alternative embodiments, the front cork layer may be configured to form a backing layer of the building panel 10.

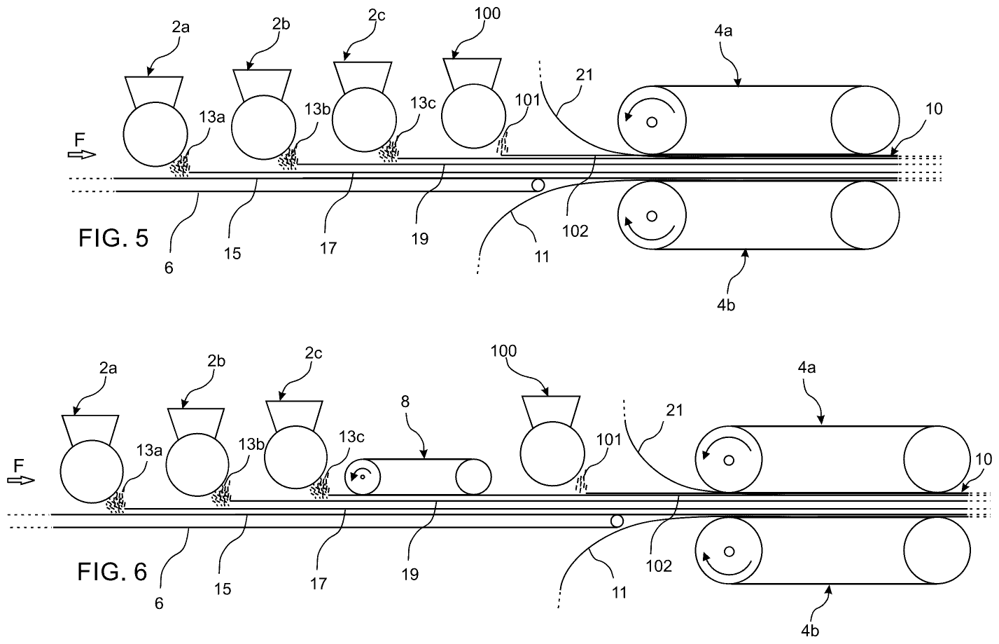

In the embodiment illustrated in FIGS. 2 and 6, the cork particles 101 are applied on the front side layer 19 after the pre-pressure step. The pre-pressure step will be described below in further details with reference to FIGS. 2 and 6.

In further embodiments of the present disclosure, there may be yet further layers (not illustrated) applied before applying the heat and pressure to form the building panel.

Such layers may comprise a mixture in accordance with any mixture described above with at least lignocellulosic particles and a binder. If the additional layer/s is further a decorative layer the mixture may comprise colorant. The mixture may be applied in dry form or wet form and may in an embodiment be a powder. The mixture may be applied with any of the above described amounts. In an embodiment a yet further layer may be a coating layer. In another embodiment a yet further layer may comprise wear resistant particles, such as aluminium oxide particles, or scratch resistant particles. This may be preferred if the yet further layer is a top layer of the building panel.

There are, however, some differences in the setups between the production methods as illustrated in FIGS. 1, 2 and 4-7. Each method is, however, possible in order to achieve a building panel 10 according to the present disclosure.

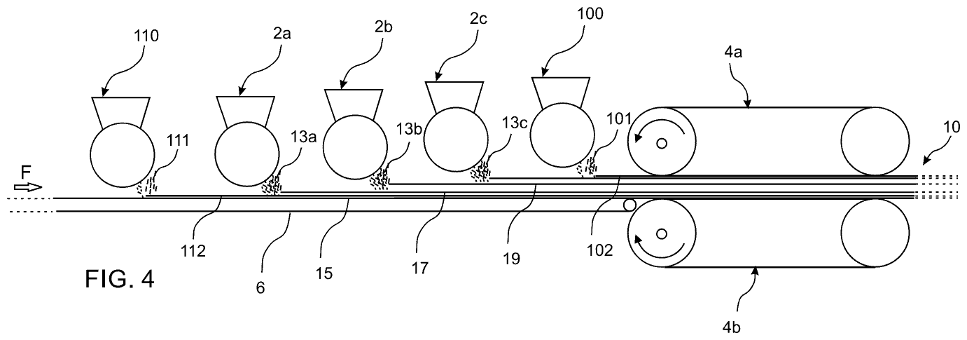

In the embodiment illustrated in FIG. 4, the multi-layered substrate is provided with a back cork layer 112. In the embodiment illustrated in FIG. 4, cork particles 111 are applied by a fifth application device 110. The cork particles 111 are applied on a carrier 6, such as a carrier belt or conveyor belt.

The cork particles 111 may applied as loose, or free, particles, The cork particles 111 may be granulated cork material. The cork particles 111 may be scattered by the fifth applicator device 110.

The cork particles 111, such as the granulated cork material, applied on the carrier 6 may be free from added binder. The cork particles 111, such as the granulated cork material, may comprise natural resins, such as suberin and/or lignin. By free from added binder is understood free from binder not being naturally occurring in the cork particles 111, or in the cork particles 111 in form of granulated cork material. Thereby, the back cork layer 112 may consist of the cork particles 111, such as the granulated cork material, prior to applying pressure and heat.

The cork particles 111, such as the granulated cork material, may be applied on the carrier 6 in an amount of 100-400 g/m², for example in an amount of 150-300 g/m², such as about 200 g/m². The amount of the first mixture 13a may be reduced by an amount corresponding to the amount of the cork particles 111 applied on the carrier 6.

The first mixture 13a is applied on the back cork layer 112 of the cork particles 111.

The granulated cork material may have a particle size of 0.5-4 mm. 100 wt. % of the granulated cork material may have a particle size of 0.5-4 mm. At least 80 wt. % of the granulated cork material may have a particle size of 1-3 mm.

After pressure and heat has been applied to the back cork layer 112, the back cork layer 112 may have a thickness of 0.5-1 mm.

The first mixture 13a, the second mixture 13b, the third mixture 13c, and the cork particles 111 forming the front cork layer 102 are applied as previously described with reference to FIGS. 1, 2 and 5-7.

As previously described with reference to FIGS. 1, 2 and 5-7, pressure and heat are applied to the multi-layered substrate, comprising at least the back cork layer 112, the back side layer 15, the intermediate layer 17, the front side layer 19, and the front cork layer 102, for example by the heat and pressure devices 4a, 4b previously described, also referred to as panel forming devices 4a, 4b.

When applying pressure and heat, the back cork layer 112 is bonded at least to the back side layer at least partly by the binder of the first mixture 13a. During applying pressure and heat, the binder originating from the first mixture 13a may permeate into the back cork layer 112, thereby bonding the back cork layer 112 to the back side layer 15.

When applying pressure and heat, the cork particles 111, such in form of the granulated cork material, are bonded to each other at least partly by natural resins of the cork material. Natural resins may be suberin and lignin.

Further, the cork particles 111, such in form of the granulated cork material, may at least partly bond to each other by the binder of the first mixture 13a. At least cork particles 111 located adjacent the back side layer 15 may at least partly bond to each other by the binder of the first mixture 13a. During applying pressure and heat, the binder originating from the first mixture 13a may permeate into a portion of the back cork layer 112, thereby bonding cork particles and/or bonding the back cork layer 10′12 to the back side layer 15.

However, after pressure and heat have been applied to the multi-layered substrate, a surface of the back cork layer 112 opposite the back side layer 15 may be at least substantially free from added binder. By being substantially free from added binder may imply free from any binder not naturally occurring in the cork particles. By the surface of the back cork layer 112 being free from added binder may comprise that at least 80% of the surface may be free from added binder, such as at least 90% of the surface may be free from added binder. In one embodiment the back cork layer 112 may be free from added binder.

In FIGS. 1, 2, 5, and 6 the first mixture 13a is applied onto a carrier 6, in the illustrated example a carrier belt or conveyor belt.

In the embodiment illustrated in FIGS. 5 and 6 a back side element 11, such as a balancing layer, and a front side layer 21, e.g., a wood veneer, are being introduced. The first mixture 13a, the second mixture 13b and the third mixture 13c are transferred onto the back side element 11 such that the first mixture 13a is applied onto to back side element 11. The back side element 11 may be a wood veneer element. However, the back side element 11 may in other embodiments be a paper, an unimpregnated paper or an impregnated paper, a polymer-based sheet, a cork-based element, a prefabricated powder-based sheet, a powder layer comprising wood fibres and binder, or any other suitable back side element.

Further, the front side element 21 is applied onto the front cork layer 102. The front side element 21 may be a wood veneer element. The front side element 21 may in other embodiments be a paper sheet, a resin impregnated paper sheet, a polymer-based sheet, a prefabricated powder-based sheet, a powder layer comprising wood fibres and binder or, any other suitable front side element. Further, the front side element may be combined with a suitable wear layer, such as a lacquer, an overlay sheet, or any other layer comprising e.g., wear resistant particles, such as aluminium oxide particles, and/or scratch resistant particles, either before pressure and heat is applied or after the building panel has been formed.

After the front side element 21 and the back side element 11 are in place pressure and heat are applied to form the building panel 10.

In the embodiment illustrated in FIGS. 1 and 2 neither a back side element nor a front side element is present, thus, pressure and heat are applied directly to the first mixture 13a and the cork particles 101 for forming the building panel 10. In the embodiment illustrated in FIG. 4, pressure and heat are applied directly to the cork particles 111 forming the back cork layer 112 and the cork particles 101 forming the front cork layer 102 for forming the building panel 10.

Pressure and heat are applied preferably by a combined heat and pressure device as the building panel forming device 4a, 4b. In the illustrated examples of FIGS. 1, 2, 4-7 there is one combined heat and pressure device 4a, 4b on each opposite sides of the building panel 10. The heat and pressure devices 4a, 4b are also illustrated as continuous heat and pressure devices feeding the building panel 10 in the feeding direction F.

In alternative setups the heat and pressure devices may be discontinuous devices. It is further possible to only have one single heat and pressure device instead of a double as illustrated. Also, it is possible to have a combined heat and pressure device operating from one side of the building panel and a pressure device, with no added heat, operating from the opposite side of the building panel.

When forming the building panel 10 in a continuous pressing device a pressure of between 20-80 bar, between 40-80 bar, between 50-70 bar, about 50 bar, or about 60 bar is applied, which is applied at a press factor of between 6-16 s/mm, between 7-14 s/mm, or between 8-12 s/mm. Further, a temperature in the press board of between 120-250° C., between 130-200° C., or about 160-180° C. is applied.

In an embodiment the method of forming the building panel 10 may further include creating a pattern in the top surface of the front side layer 19 or, if present, the front side element 21 simultaneously with applying pressure and heat to form the building panel 10. This may be achieved e.g., by a structured press plate (not shown) in the heat and pressing device 4a, or with a displaceable pressing sheet (not shown) which can be arranged in between the front surface of the front side layer 19 or the front side element 21 and the heat and pressure device 4a. By having such a feature in the method, it is possible to achieve a desirable and attractive structure or different gloss levels in the top surface.

After the building panel 10 has been formed by the heat and pressure devices 4a, 4b the back side layer 15, the intermediate layer 17 and the front side layer 19, more specifically the binder of each layer, are cured.

Further, if a front side element 21 and/or a back side element 11 is present, the front side layer 19 is attached to the front side element 21 and the back side layer 15 is attached to the back side element 11. Yet further, the front side layer 19 has penetrated into open features 22, if such are present, of the front side element 21, especially if the front side element 21 is a wood veneer element. Open features 22 may be cracks, holes, pores, etc. The front side layer 19 penetrates and at least party fills such open features 22 when heat and pressure is applied. It may be preferred that the front side layer 19 completely fills the open features 22 of the front side element 21.

After the building panel 10 has been heated and pressed the method may further comprise a cooling device (not shown). The cooling device is configured to control the cooling process of the formed building panel and to prevent the building panel to change shape and created unwanted forces within and between the layers of the building panel.

In FIGS. 2 and 6 the methods in FIGS. 1 and 5 are illustrated but with an addition of a pre-pressure method step. Everything that has been described above with reference to FIGS. 1 and 5 also applies for the methods as illustrated in FIGS. 2 and 6.

If yet further layer/s is applied, as described above, the pre-pressing step may be achieved either before or after such further layer/s is applied.

In an embodiment there may be more than one pre-pressing steps.

The addition of the pre-pressure method step is arranged either before the front side element 21 and the back side element 11 is applied, as illustrated in FIG. 6, or before the main pressure method step is applied to the mixtures 13a, 13b, 13c, as illustrated in FIG. 2. The pre-pressure method step is achieved by a pressure device 8, in the illustrated example a continuous pressing device. The pressure device 8 is configured to press out unwanted air from the first mixture 13a, the second mixture 13b and the third mixture 13c such that unwanted air is not contained and trapped within the back side layer 15, the intermediate layer 17 and the front side layer 19 when the mixtures 13a, 13b, 13c, and more specifically the binders in each mixture 13a, 13b, 13c, are cured. The pressing device 8 is not configured to cure the binders of the mixtures 13a, 13b, 13c, or at least not configured to completely cure the binders of the mixtures 13a, 13b, 13c. The pressing device 8 is arranged after the third mixture 13c has been applied to the second mixture 13b.

In the embodiment illustrated in FIG. 6, the cork particles 101 are applied after the pre-pressure step. The front side element 21 is applied on the cork front layer 102 formed by the cork particles 102 prior to applying pressure and heat in the heat and pressure devices 4a, 4b as previously described.

FIG. 3A illustrate a possible continued process of the building panel 10 after the front cork layer 102, the front side layer 15, the intermediate layer 17 and the back side layer 19 have been formed in the heat and pressure devices 4a, 4b as illustrated in FIGS. 1 and 2. The method may further include to apply a front side element 21 after the step of applying heat and pressure. Before the front side element 21 is applied it is preferred to add e.g., an adhesive 7a such as glue or the like, onto the top surface of the front cork layer 102. The adhesive 7a may be applied by means of a second applicator device 7 which is arranged before the front side element 21 is applied onto the front cork layer 102. The front side element 21 may be chosen from a group of a wood veneer element, a paper sheet, a resin impregnated paper sheet or an unimpregnated paper sheet, a polymer-based sheet, a prefabricated powder-based sheet, a powder layer comprising wood fibres and binder, a foil, such as a thermoplastic foil, or a coating layer, such as a lacquer.

In an embodiment, such front side element 21 is configured to receive a print, such as a digital print and/or an analog print. Any of the mentioned front side elements may further be combined with a suitable wear layer, such as a lacquer, an overlay sheet, or any other layer comprising e.g., wear resistant particles, such as aluminium oxide particles, and/or scratch resistant particles.

FIG. 3B illustrate another possible continued process of the building panel 10 after the front cork layer 102, the front side layer 15, the intermediate layer 17 and the back side layer 19 have been formed and the binders of the layers 15, 17, 19 have been cured in the heat and pressure devices 4a, 4b as illustrated in FIGS. 1 and 2. The method may further include to apply a top layer 7b which can be decorative, functional and/or protective. E.g., a decorative surface, such as a painted surface which is able to receive a print, such as a digital print and/or an analog print, a coating layer such as a lacquered layer, or a combination of such layers, after the step of applying heat and pressure. The top layer 7b may be applied by means of a second applicator device 7.

In one embodiment a coating 7b is applied on the front cork layer 102 by the second application device 7 as illustrated in FIG. 3B. The coating 7b may be a UV curable coating. The coating 7b may further comprise wear resistant particles such as aluminium oxide particles, and/or scratch resistant particles.

In FIGS. 5 and 6 the first mixture 13a is applied onto a carrier 6, in the illustrated example a conveyor belt. Once the first mixture 13a, the second mixture 13b and the third mixture 13c have been applied a back side element 11 and a front side element 21 are being introduced. The first mixture 13a, the second mixture 13b and the third mixture 13c, the cork particles 101 are transferred onto the back side element 11 such that the first mixture 13a is applied onto to back side element 11. The front side element 21 may be chosen from a group of a wood veneer element, a paper sheet, a resin impregnated paper sheet, or an unimpregnated paper sheet, a polymer-based sheet, a prefabricated powder-based sheet, a powder layer comprising wood fibres and binder, a foil, such as a thermoplastic foil, or a coating layer, such as a lacquer.

In an embodiment, such front side element 21 may be configured to receive a print, such as a digital print and/or an analog print. Any of the mentioned front side elements may further be combined with a suitable wear layer, such as a lacquer, an overlay sheet, or any other layer comprising e.g., wear resistant particles, such as aluminium oxide particles, and/or scratch resistant particles.

The back side element 11 may be a balancing layer. The back side element 11 may be a balancing layer which is chosen to correspond to the front side element 21, i.e., if the front side element 21 is a wood veneer element the back side layer 11 may be a wood veneer element in order to create a symmetry in the building panel 10, or if the front side element 21 is a paper sheet the back side layer 11 may be the same type of paper sheet for the same reason. However, it may be possible to choose a back side element 11 not corresponding to the front side element 21.

Further, the front side element 21 is applied onto the cork particles 101 forming the front cork layer 102.

Further, to improve adherence to the front side element 21 an adhesive may be provided. The adhesive may be applied on a surface of the front side element 21 facing the front cork layer 102. As an alternative or complement, an adhesive may be applied on the front cork layer 102 prior to applying the front side element 21. As an alternative or complement, a binder may be applied, for example, scattered, on the front cork layer 102 prior to applying the front side element 21.

Further, if a back cork layer 112 is present, as illustrated in FIG. 4, an adhesive may be applied may be applied on a surface of the back side element 11 facing the back cork layer 112. As an alternative or complement, an adhesive may be applied on the back cork layer 112 prior to applying the back side element 11. As an alternative or complement, a binder may be applied, for example, scattered, on the back cork layer 112 prior to applying the back side element 11.

After the front side element 21 and the back side element 11 are in place pressure and heat is applied to form the building panel 10. Pressure and heat are applied preferably by a combined heat and pressure device as the building panel forming device 4a, 4b. In the illustrated examples of FIGS. 1, 2 and 4-7 there is one combined heat and pressure device 4a, 4b on each opposite sides of the building panel 10. The heat and pressure devices 4a, 4b are also illustrated as continuous heat and pressure devices feeding the building panel 10 in the feeding direction F.

In alternative setups the heat and pressure devices may be discontinuous devices. It is further possible to only have one single heat and pressure device instead of a double as illustrated. Also, it is possible to have a combined heat and pressure device operating from one side of the building panel and a pressure device, with no added heat, operating from the opposite side of the building panel.

Which has been previously described, when forming the building panel 10 in a continuous pressing device a pressure of between 20-80 bar, between 40-80 bar, between 50-70 bar, or about 50 bar, or about 60 bar is applied, which is applied at a press factor of between 6-16 s/mm, between 7-14 s/mm, or between 8-12 s/mm. Further, a temperature in the press board of between 120-250° C., between 130-200° C., or about 160-180° C. is applied.

In an embodiment the method of forming the building panel 10 may further include creating a pattern in the top surface of the front cork layer 102 or in the front side element 21 simultaneously with applying pressure and heat to form the building panel 10. This may be achieved e.g., by a structured press plate (not shown) in the heat and pressing device 4a, or with a displaceable pressing sheet (not shown) which can be arranged in between the front surface of the front side element 21 or the front cork layer 102 and the heat and pressure device 4a. By having such a feature in the method, it is possible to achieve a desirable and attractive structure, or different gloss levels in the top surface.

After the building panel 10 has been formed by the heat and pressure devices 4a, 4b the back side layer 15, the intermediate layer 17 and the front side layer 19, more specifically the binders of the layers 15, 15, 19, are cured.

Further, the front side layer 19 is attached to the front side element 21 via the front cork layer 102 and the back side layer 15 is attached to the back side element 11, optionally via the back cork layer 112. Yet further, the front cork layer 102, or at least material originating from the front cork layer 102 has permeated into open features 22, if such are present, of the front side element 21. Open features 22 may be cracks, holes, pores, etc. The front cork layer 102, or at least material originating from the front cork layer 102, penetrates and at least party fills such open features 22 when heat and pressure is applied. It may be preferred that the front cork layer 102, or at least material originating from the front cork layer 102 completely fills the open features 22 of the front side element 21.

After the building panel 10 has been heated and pressed the method may further comprise a cooling device (not shown). The cooling device is configured to control the cooling process of the formed building panel and to prevent the building panel to change shape and created unwanted forces within and between the layers of the building panel.

In FIG. 6, the method of FIG. 5 is illustrated with an addition of a pre-pressure method step. Everything that has been described above with reference to FIG. 6 also applies for the method as illustrated in FIG. 5.

The addition of the pre-pressure method step is preferably arranged before the front side element 21 and the back side element 11 is applied. The pre-pressure method step is achieved by a pressure device 8, in the illustrated example a continuous pressing device. The pressure device 8 is configured to press out unwanted air from the first mixture 13a, the second mixture 13b and the third mixture 13c such that unwanted air is not contained and trapped within the back side layer 15, the intermediate layer 17 and the front side layer 19 when the mixtures 13a, 13b, 13c, more specifically the binders of the mixtures 13a, 13b, 13c, are cured. The pressing device 8 is not configured to cure the binders of the mixtures 13a, 13b, 13c, or at least not configured to completely cure the binders of the mixtures 13a, 13b, 13c. The pressing device 8 is arranged after the third mixture 13c has been applied to the second mixture 13b.

In an alternative embodiment (not shown), the pressing device 8 may be arranged after the cork particles 101 and the third mixture 13c has been applied to the second mixture 13b. The pressure device 8 is then configured to press out unwanted air from the cork particles 101, the first mixture 13a, the second mixture 13b and the third mixture 13c such that unwanted air is not contained and trapped within the cork particles 101, the back side layer 15, the intermediate layer 17 and the front side layer 19 when the mixtures 13a, 13b, 13c, more specifically the binders of the mixtures 13a, 13b, 13c, are cured.

A further advantage with the pre-pressing method step, besides of removing unwanted air from the mixtures 13a, 13b, 13c, is that the mixtures after the pre-pressing method step may be easier to handle and easier to transfer from the carrier 6 to e.g., the back side element 11 before the building panel 10 is formed.

In FIG. 7 the cork particles 111 forming the back cork layer 112 is, unlike what is illustrated in FIG. 4 and unlike illustrated in FIGS. 5-6, applied directly onto the back side element 11. The first mixture 13a is applied on the cork particles 111. The back side element 11 is then transported on the carrier 6, i.e., the conveyor belt in the illustrated example, together with the applied cork particles 111, the first mixture 13a, second mixture 13b, third mixture 13c, and the cork particles 101 before the front side element 21 is applied on the third mixture 13c and transferred into the combined heat and pressure devices 4a, 4b for forming the building panel 10.

Just like in FIGS. 5 and 6, after the front side element 21 is in place, pressure and heat is applied to form the building panel 10. Pressure and heat are applied preferably by the combined heat and pressure devices 4a, 4b.

In alternative setups the heat and pressure devices may be discontinuous devices. It is further possible to only have one single heat and pressure device instead of a double as illustrated. Also, it is possible to have a combined heat and pressure device operating from one side of the building panel and a pressure device, with no added heat, operating from the opposite side of the building panel.

Which has been previously described, when forming the building panel 10 in a continuous pressing device a pressure of between 20-80 bar, between 40-80 bar, between 50-70 bar, or about 50 bar, or about 60 bar is applied, which is applied at a press factor of between 6-16 s/mm, between 7-14 s/mm or between 8-12 s/mm. Further, a temperature in the press board of between 120-250° C., between 130-200° C., or about 160-180° C. is applied.

After the building panel 10 has been formed by the heat and pressure devices 4a, 4b, as the building panel forming device, the back side layer 15, the intermediate layer 17 and the front side layer 19, more specifically the binders of each layer 15, 17, 19, are cured. Further, the front side layer 19 is, if a front side element 21 and/or a back side element 11 is present, attached to the front side element 21 and the back side layer 15 is attached to the back side element 11. Yet further, the front side layer 19 has penetrated into open features 22, if such are present, of the front side element 21, especially if the front side element 21 is a wood veneer element. Open features 22 may be cracks, holes, pores, etc. The front side layer 19 penetrates and at least party fills such open features 22 when heat and pressure is applied. It may be preferred that the front side layer 19 completely fills the open features 22 of the front side element 21.

After the building panel 10 has been heated and pressed the method may further comprise a cooling device (not shown), which has been previously described. The cooling device is configured to control the cooling process of the formed building panel and to prevent the building panel to change shape and created unwanted forces within and between the layers of the building panel.

For the embodiment illustrated in FIG. 7 it may also be possible and preferred to add the pre-pressing method step as described with reference to FIGS. 2 and 6 above, in order to remove unwanted air from the mixtures 13a, 13b, 13c. The pressure device (not shown in this embodiment) may then be arranged after the third mixture 13c has been applied and before the, optional, front side element 21 has been applied on the third mixture 13c.

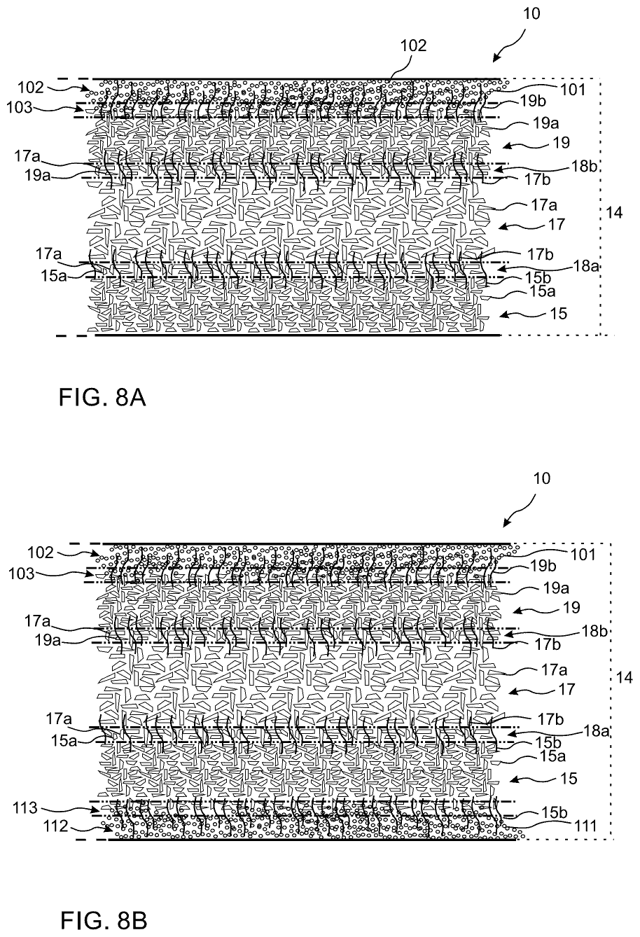

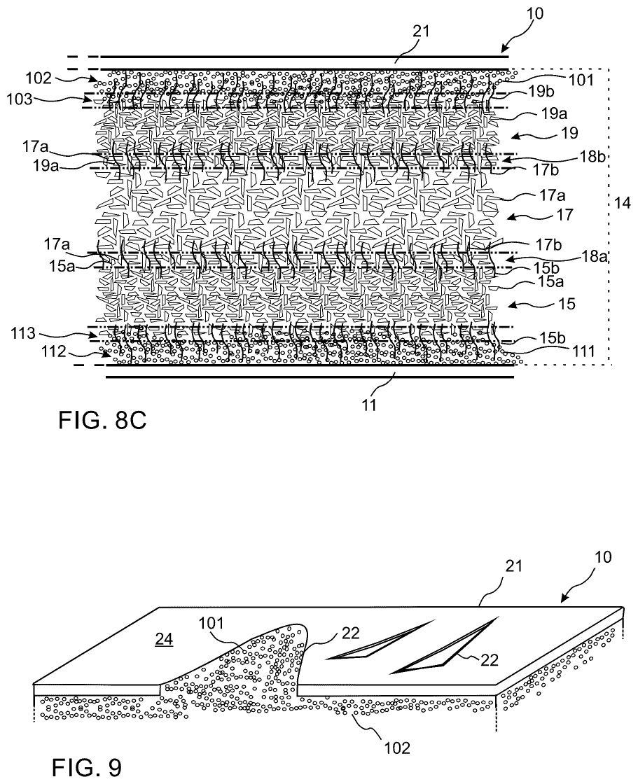

FIG. 8A is a schematic illustration of a cross section of a formed building panel 10 comprising the front cork layer 102, manufactured by any of the methods illustrated in FIG. 1 or 2. FIG. 8B is a schematic illustration of a cross section of a formed building panel 10 comprising the front cork layer 102 and the back cork layer 112, manufactured by the method illustrated in FIG. 4. FIG. 8C is a schematic illustration of a cross section of a formed building panel 10 the front cork layer 102 and the back cork layer 112, manufactured by the method illustrated in FIG. 7. Alternatively, the building panel 10 illustrated in FIG. 8C may be manufactured by method illustrated in FIG. 4, wherein the front side layer 21 and the back side layer 11 have been applied after applying pressure and heat, as illustrated in FIG. 3A. The disclosure below relates to the embodiments illustrated 8A-C, unless reference is made to a specific figure.

The building panel 10 may have a total thickness of between 4 mm and 28 mm.

As explained above, the back side layer 15 has been formed from the first mixture 13a and includes at least lignocellulosic particles 15a and a binder 15b. The intermediate layer 17 is formed from the second mixture 13b and includes at least lignocellulosic particles 17a and a binder 17b. The front side layer 19 is formed from the third mixture 13c and includes at least lignocellulosic particles 19a and a binder 19b.

In between the back side layer 15 and the intermediate layer 17, respective between the intermediate layer 17 and the front side layer 19, there is a border area 18a, 18b between the layers in which lignocellulosic particles 15a, 17a, 19a and occasionally also binder 15b, 17b, 19b from respective layer 15, 17, 19 have been mixed. I.e., in a lower border area 18a, which can also be called a lower transition area, at least lignocellulosic particles 15a, 17a from the back side layer 15 and the intermediate layer 17 are mixed, and in an upper border area 18b, which can also be called an upper transition area, at least lignocellulosic particles 17a, 19a from the intermediate layer 17 and the front side layer 19 are mixed.

In between the front cork layer 102 and the front side layer 19, there may be a border area 103 between the layers in which lignocellulosic particles 19a and/or binder 19b of the third mixture 13a forming the front side layer 19 mixed with the cork particles 101 of the front cork layer 102, as illustrated in FIGS. 8A-C. The binder 19b of the front side layer 19 may have permeated into a portion of the front cork layer 102 extending in a direction parallel to a thickness direction of the front cork layer 102.

Similarly, as illustrated in FIGS. 8B-C, in between the back cork layer 112 and the back side layer 15, there may be a border area 113 between the layers in which lignocellulosic particles 15a and/or binder 15b of the first mixture 13a forming the back side layer 15 is mixed with the cork particles 111 of the back cork layer 112. The binder 15b of the back side layer 15 may have permeated into a portion of the back cork layer 112 extending in a direction parallel to a thickness direction of the back cork layer 112.

The front cork layer 102 and/or the back cork layer 112 may have a thickness of 0.5-1 mm.

The front cork layer 102 is bonded at least to the front side layer 19 at least partly by the binder of the third mixture 13c. The binder originating from the third mixture 13c may permeate into the front cork layer 102, thereby bonding the front cork layer 102 to the front side layer 19.

The cork particles 101, such in form of the granulated cork material, are bonded to each other at least partly by natural resins of the cork material. Natural resins may be suberin and lignin.

Further, the cork particles 101, such in form of the granulated cork material, may at least partly bond to each other by the binder of the third mixture 13c. At least cork particles 101 located adjacent the front side layer 19 may at least partly bond to each other by the binder of the third mixture 13c.

A surface of the front cork layer 102 opposite the front side layer 19 may be at least substantially free from added binder. By being substantially free from added binder may imply free from any binder not naturally occurring in the cork particles. By the surface of the front cork layer being free from added binder may comprise that at least 80% of the surface may be free from added binder, such as at least 90% of the surface may be free from added binder. In one embodiment the front cork layer may be free from added binder.

The front cork layer 102 may be configured to form a surface layer of the building panel 10, optionally with a coating and/or a wear resistant layer such as an overlay. In other embodiments, the front cork layer 102 may be provided with a front side element 21, either after applying pressure and heat as illustrated in FIG. 3A, or before applying pressure and heat as illustrated in FIGS. 4-7.

In alternative embodiments, the front cork layer may be configured to form a backing layer of the building panel 10.

The back cork layer 112 is bonded at least to the back side layer 15 at least partly by the binder of the first mixture 13a. The binder originating from the first mixture 13a may permeate into the back cork layer 112, thereby bonding the back cork layer 112 to the back side layer 15.

The cork particles 111, such in form of the granulated cork material, are bonded to each other at least partly by natural resins of the cork material. Natural resins may be suberin and lignin.

Further, the cork particles 111, such in form of the granulated cork material, may at least partly bond to each other by the binder of the first mixture 13a. At least cork particles 111 located adjacent the back side layer 15 may at least partly bond to each other by the binder of the first mixture 13a.

A surface of the back cork layer 112 opposite the back side layer 15 may be at least substantially free from added binder. By being substantially free from added binder may imply free from any binder not naturally occurring in the cork particles. By the surface of the front cork layer being free from added binder may comprise that at least 80% of the surface may be free from added binder, such as at least 90% of the surface may be free from added binder. In one embodiment the surface of the front cork layer may be free from added binder.

FIG. 8C is a schematic illustration of a cross section of a formed building panel 10, manufactured by any of the methods illustrated in FIGS. 5-7, illustrating the different components of the building panel. The building panel 10 may have a total thickness of between 4 mm and 28 mm.

On the bottom, there is the back side element 11, in this case a wood veneer element, and on the top, there is the front side element 21, in this case a wood veneer element. The front side element 21 may alternatively be for example a paper sheet, a resin impregnated paper sheet, a polymer-based sheet, or a prefabricated powder-based sheet. The back side element 11 may alternatively be a paper sheet, a resin impregnated paper sheet, a polymer-based sheet, a prefabricated powder-based sheet, or a powder layer comprising wood fibres and binder.

The back side element 11 may be the same as the front side element 21. However, the back side layer 11 may in other embodiments be, e.g., a paper, an unimpregnated paper or an impregnated paper, while the front side layer 21 is a decorative layer, such as a decorative wood veneer layer

A front side element 21 of the building panel may comprise a thermoset resin, for example an amino resin such as melamine formaldehyde, urea formaldehyde, phenol formaldehyde resins, or combinations thereof, or no-added formaldehyde resins such as epoxy resins, acrylic resins, polyurethane resins, polymeric diphenylmethane diisocyanate resin, polyester resins, or combinations thereof.

A front side element 21 of the building panel may comprise thermoplastic materials, such as polyvinyl chloride (PVC), polyvinyl butyral (PVB), polyethylene (PE), polypropylene (PP), thermoplastic polyurethane (TPU), acrylonitrile butadiene styrene (ABS), polystyrene (PS), polyethylene terephthalate (PET), polyethylene terephthalate glycol (PETG), polyethersulfone (PES), or combinations thereof.

A back side element 11 of the building panel may comprise a thermoset resin, for example an amino resin such as melamine formaldehyde, urea formaldehyde, phenol formaldehyde resins, or combinations thereof, or no-added formaldehyde resins such as epoxy resins, acrylic resins, polyurethane resins, polymeric diphenylmethane diisocyanate resin, polyester resins, or combinations thereof.

A back side element 11 of the building panel may comprise thermoplastic materials, such as polyvinyl chloride (PVC), polyvinyl butyral (PVB), polyethylene (PE), polypropylene (PP), thermoplastic polyurethane (TPU), acrylonitrile butadiene styrene (ABS), polystyrene (PS), polyethylene terephthalate (PET), polyethylene terephthalate glycol (PETG), polyethersulfone (PES), or combinations thereof.

In the embodiment illustrated in FIG. C, both a front side element 21 and a back side element 11 are provided. However, the building panel may be provided with only the front side element 21, or the back side element 11.

In between the back side element 11 and the front side element 21 there is a multi-layered substrate 14 including the back cork layer 112, the back side layer 15, the intermediate layer 17, the front side layer 19, and the front cork layer 102.

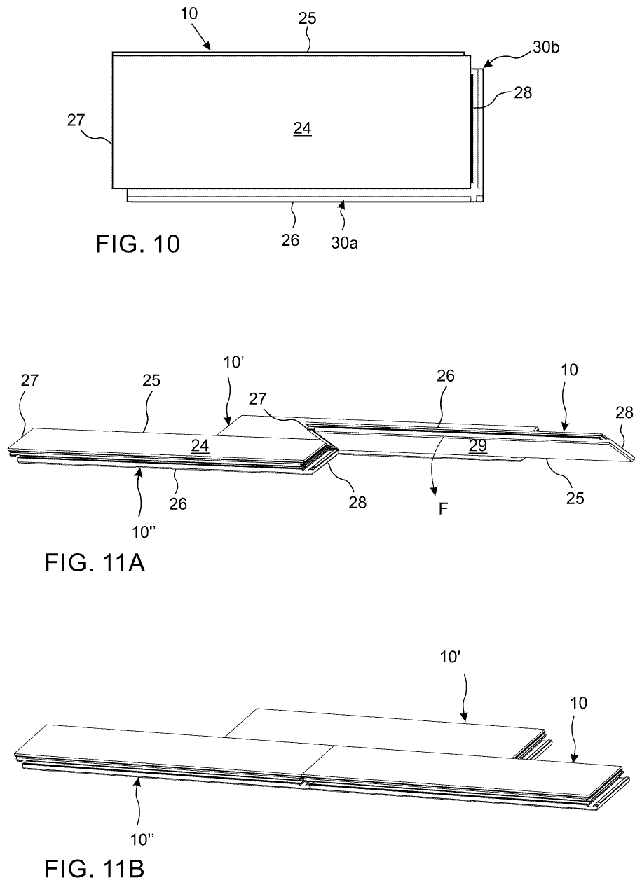

Further, as illustrated in FIG. 10, the cork particles 101 are adapted to penetrate open features 22 in the front side element 21 if the front side element 21 has such open features 22, e.g., common where the front side element 21 is a wood veneer element, such that the cork particles 101 at least partly fills the open features 22. Open features may be cracks, holes, pores, or the like. The front cork layer 102 may further includes colorant 19c. The colorant may be a pigment, dye, or a chemical staining agent. An example of a chemical staining agent is iron vitriol. By having a colorant in the front side layer 19 is possible to control and adapt appearance features of the top surface 24 of the building panel 10. For example if the front side element 21 has open features 22, such as cracks, holes, or the like, the colorant of the front cork layer 102 is configured to colour the open features 22 as material from the front cork layer 102, penetrates into the open features 22 and at least partly fills such open features 22 when pressure is subsequently is applied. Material from the front cork layer 102 may substantially fill such open features 22, as illustrated in FIG. 10.

As described above, the back side layer 15 is made from the first mixture 13a, thus the back side layer 15 includes at least the lignocellulosic particles 15a and the binder 15b. The lignocellulosic particles 15a may be wood particles, e.g., made of pine, oak, eucalyptus, or other wood species, straws from grain products, sisal, coconut, bamboo, hemp, flax, jute, curaua, ramie, or any combination of such particles. The lignocellulosic particles 15a make up between 70 wt. % and 99 wt. %, or above 85 wt. % of the back side layer 15.

The majority, i.e., at least 50 wt. %, of the lignocellulosic particles 15a in the back side layer 15 has a particle size of between 0.3 mm and 0.6 mm. Preferably at least 60 wt. %, at least 70 wt. %, or at least 80 wt. % of the lignocellulosic particles 15a in the back side layer 15 have a particle size of between 0.3 mm and 0.6 mm. In an alternative embodiment, the majority, i.e., at least 50 wt. %, of the lignocellulosic particles in the back side layer 15 has a particle size of between 0.3 mm and 1.25 mm. Preferably at least 60 wt. %, at least 70 wt. %, or at least 80 wt. % of the lignocellulosic particles in the back side layer 15 have a particle size of between 0.3 mm and 1.25 mm.

The average particle size of the lignocellulosic particles in the back side layer may be between 0.3 mm and 1.25 mm, such as between 0.3 and 0.6 mm.

The lignocellulosic particles 15a in the back side layer 15 can also be measured by an aspect ratio, i.e., the ratio between the length of the particle and its width. The aspect ratio of the majority, i.e., at least 50%, of the lignocellulosic particles 15a is below 30. Preferably at least 60%, at least 70%, or at least 80% of the lignocellulosic particles 15a have an aspect ratio below 30, or below 10. The aspect ratio of the majority, i.e., at least 50%, of the lignocellulosic particles 15a in the back side layer 15 is between 1:1 and 30:1, between 1:1 and 20:1, or between 1:1 and 10:1. Preferably the aspect ratio of at least 60%, at least 70%, or at least 80% of the lignocellulosic particles 15a is between 1:1 and 30:1, between 1:1 and 20:1, or between 1:1 and 10:1. At least 50 wt. %, of the lignocellulosic particles 15a in the back side layer 15 has a particle size of between 0.3 mm and 1.25 mm, or between 0.3 mm and 0.6 mm, and an aspect ratio less than 30 or less than 20. In an embodiment the particle size of the lignocellulosic particles 15a in the back side layer 15 is between 0.3 mm and 1.25 mm, or between 0.3 mm and 0.6 mm and with an aspect ratio less than 10.

The binder 15b in the back side layer 15 may be a thermoset resin. Examples of suitable thermoset resins are amino resins such as melamine formaldehyde, urea formaldehyde, phenol formaldehyde resins, or combinations thereof, or no-added formaldehyde resins such as epoxy resins, acrylic resins, polyurethane resins, polymeric diphenylmethane diisocyanate resin, polyester resins, or combinations thereof. The binder 15b make up between 5 wt. % and 30 wt. %, or between 10 wt. % and 25 wt. % of the back side layer 15. As described above, common in wood industry, the amounts are calculated on dry weight, with the amount of bone-dry wood=100% as base.

The amount of binder 15b in the back side layer 15, or in any of the layers 17, 19 in this disclosure, may affect the water resistant or water repellent properties of the layers 15, 17, 19 of the building panel 10. E.g., having more binder in the layers 15, 17, 19 may increase the water resistant or water repellent properties in the building panel 10. However, binder is also the more expensive component of the mixture, thus, an amount as defined above gives a beneficial balance between effect and cost.

Another way of increasing the water resistant or water repellent properties in the building panel is for the back side layer 15 to further include hydrophobing agent, such as wax. The back side layer 15 may comprise 1-3 wt. %, or 1-2 wt. % of the hydrophobing agent. As described above, common in wood industry, the amounts are calculated on dry weight, with the amount of bone-dry wood=100% as base.

Preferred hydrophobing agents are paraffin emulsions. An advantage with having a hydrophobing agent in the layers 15, 17, 19 of the building panel 10 is that it provides the layers 15, 17, 19 with improved water repellent properties, in turn creating a more water resistant building panel 10. It may thus be beneficial to have a hydrophobing agent in the layer 15, 17, 19 in which features for increasing the water resistant properties of the building panel 10 are created. Examples of this will be described later on.

The back side layer 15 may further comprise different types of additives, such as colorant, catalyst (e.g., ammonium sulphate), formaldehyde scavenger (e.g., urea), or buffer solution. As described above, the intermediate layer 17 is made from the second mixture 13b, thus, the intermediate layer 17 includes at least lignocellulosic particles 17a and the binder 17b.

The lignocellulosic particles 17a in the intermediate layer 17 may be wood particles, e.g., made of pine, oak, eucalyptus, or other wood species, straws from grain products, sisal, coconut, bamboo, hemp, flax, jute, curaua, ramie, or any combination of such particles. The lignocellulosic particles 17a make up between 70 wt. % and 99 wt. %, or above 85 wt. % of the intermediate layer 17.

The majority, i.e., at least 50 wt. %, of the lignocellulosic particles 17a in the intermediate layer 17 has a particle size of between 0.5 mm and 4 mm, or 0.5 mm and 2.5 mm, or between 0.6 mm and 1.3 mm. Preferably at least 60 wt. %, at least 70 wt. %, or at least 80 wt. % of the lignocellulosic particles 17a in the intermediate layer 17 have a particle size of between 0.5 mm and 4 mm, between 0.5 mm and 2.5 mm, or between 0.6 mm and 1.3 mm. The average particle size of the lignocellulosic particles in the intermediate layer may be between 0.5 and 4 mm, such as between 0.5 and 2.5 mm, such as between 0.5 and 1.5 mm or such as between 0.6 and 1.3 mm.

The lignocellulosic particles 17a in the intermediate layer 17 can, like explained for the back side layer 15, also be measured by an aspect ratio, i.e., the ratio between the length of the particle and its width. The aspect ratio of the majority, i.e., at least 50%, of the lignocellulosic particles 17a in the intermediate layer 17 is below 30, or below 10. Preferably at least 60%, at least 70 wt. %, or at least 80% of the lignocellulosic particles 17a in the intermediate layer 17 have an aspect ratio below 30. The aspect ratio of the majority, i.e., at least 50%, of the lignocellulosic particles 17a in the intermediate layer 17 is between 1:1 and 30:1, between 1:1 and 20:1, or between 1:1 and 10:1. Preferably the aspect ratio of at least 60%, at least 70%, or at least 80% of the lignocellulosic particles 17a in the intermediate layer 17 is between 1:1 and 30:1, between 1:1 and 20:1, or between 1:1 and 10:1. At least 50 wt. %, of the lignocellulosic particles 17a in the intermediate layer 17 has a particle size of between 0.6 mm and 2.5 mm, or between 0.6 mm and 1.3 mm, and an aspect ratio less than 30, or less than 10. In an embodiment the particle size of the lignocellulosic particles 17a in the intermediate layer 17 is between 0.6 mm and 2.5 mm, or between 0.6 mm and 1.3 mm and with an aspect ratio less than 10.

The binder 17b in the intermediate layer 17 may be a thermoset resin. Examples of suitable thermoset resins are amino resins such as melamine formaldehyde, urea formaldehyde, phenol formaldehyde resins, or combinations thereof, or no-added formaldehyde resins such as epoxy resins, acrylic resins, polyurethane resins, polymeric diphenylmethane diisocyanate resin, polyester resins, or combinations thereof. The binder 17b in the intermediate layer 17 may be the same binder as in the back side layer 15.

The binder 17b make up between 3 wt. % and 20 wt. %, or between 5 wt. % and 10 wt. % of the intermediate layer 17. As described above, common in wood industry, the amounts are calculated on dry weight, with the amount of bone-dry wood=100% as base.

The amount of binder 17b in the intermediate layer 17, or in any of the layers 15, 19 in this disclosure, may affect the water resistant or water repellent properties of the layers 15, 17, 19 of the building panel. Having more binder in the layers 15, 17, 19 will increase the water resistant or water repellent properties in the building panel 10. However, binder is also the more expensive component of the mixture, thus, an amount as defined above gives a beneficial balance between effect and cost. In an embodiment the binder content in the intermediate layer 17 is lower than the binder content in the front side layer 19 and/or the back side layer 15.

Another way of increasing the water resistant or water repellent properties in the building panel is for the intermediate layer 17 to further include hydrophobing agent, such as wax. The intermediate layer 17 may comprise 1-3 wt. %, or 1-2 wt. % of the hydrophobing agent. Preferred hydrophobing agents are paraffin emulsions. An advantage with having a hydrophobing agent in the layers 15, 17, 19 of the building panel 10, is that it provides the layers 15, 17, 19 with improved water repellent properties, in turn creating a more water resistant building panel 10. It may thus be beneficial to have a hydrophobing agent in the layer 15, 17, 19 in which features for increasing the water resistant properties of the building panel 10 are created. Examples of this will be described later on.

The intermediate layer 17 may further comprise different types of additives, such as colorant, catalyst (e.g., ammonium sulphate), formaldehyde scavenger (e.g., urea), or buffer solution.

The front side layer 19 includes at least lignocellulosic particles 19a and the binder 19b. The lignocellulosic particles 19a in the front side layer 19 may be wood particles, e.g., made of pine, oak, eucalyptus, or other wood species, straws from grain products, sisal, coconut, bamboo, hemp, flax, jute, curaua, ramie, or any combination of such particles. The lignocellulosic particles 19a make up between 70 wt. % and 99 wt. %, or above 85 wt. % of the front side layer 19.

The majority, i.e., at least 50 wt. %, of the lignocellulosic particles 19a in the front side layer 19 has a particle length of between 0.3 mm and 0.6 mm. Preferably at least 60 wt. %, at least 70 wt. %, or at least 80 wt. % of the lignocellulosic particles in the front side layer 19 have a particle length of between 0.3 mm and 0.6 mm. In an alternative embodiment, the majority, i.e., at least 50 wt. %, of the lignocellulosic particles in the front ide layer 19 has a particle size of between 0.3 mm and 1.25 mm. Preferably at least 60 wt. %, at least 70 wt. %, or at least 80 wt. % of the lignocellulosic particles in the front side layer 19 have a particle size of between 0.3 mm and 1.25 mm. The average particle size of the lignocellulosic particles in the front side layer may be between 0.3 mm and 1.25 mm, such as between 0.3 and 0.6 mm.

The lignocellulosic particles 19a in the front side layer 19 can, as explained above, also be measured by an aspect ratio, i.e., the ratio between the length of the particle and its width. The aspect ratio of the majority, i.e., at least 50%, of the lignocellulosic particles 19a in the front side layer 19 is below 30. Preferably at least 60%, at least 70%, or at least 80% of the lignocellulosic particles 19a in the front side layer 19 have an aspect ratio below 30. The aspect ratio of the majority, i.e., at least 50%, of the lignocellulosic particles 19a in the front side layer 19 is between 1:1 and 30:1, between 1:1 and 20:1, or between 1:1 and 10:1. Preferably the aspect ratio of at least 60%, at least 70%, or at least 80% of the lignocellulosic particles 19a in the front side layer 19 is between 1:1 and 30:1, between 1:1 and 20:1, or between 1:1 and 10:1. At least 50 wt. %, of the lignocellulosic particles 19a in the front side layer 19 has a particle size of between 0.3 mm and 1.25 mm, or between 0.3 mm and 0.6 mm and an aspect ratio less than 30, or less than 10. In an embodiment the particle size of the lignocellulosic particles 19a in the front side layer 19 is between 0.3 mm and 1.25 mm, or between 0.3 mm and 0.6 mm and with an aspect ratio less than 10.

The binder 19b in the front side layer 19 may be a thermoset resin. Examples of suitable thermoset resins are amino resins such as melamine formaldehyde, urea formaldehyde, phenol formaldehyde resins, or combinations thereof, or no-added formaldehyde resins such as epoxy resins, acrylic resins, polyurethane resins, polymeric diphenylmethane diisocyanate resin, polyester resins, or combinations thereof. The binder 19b in the front side layer 19 may be the same binder as in the first back side layer 15 and/or the intermediate layer 17.

The binder 19b make up between 5 wt. % and 30 wt. %, or between 10 wt. % and 25 wt. % of the front side layer 19. The amount of binder 19b in the front side layer 19, or in any of the layers 15, 17 in this disclosure, may affect the water resistant or water repellent properties of the layers 15, 17, 19. Having more binder in the layers 15, 17, 19 will increase the water resistant or water repellent properties in the building panel 10. However, binder is also the more expensive component of the mixture, thus, an amount as defined above gives a beneficial balance between effect and cost.

Another way of increasing the water resistant or water repellent properties in the building panel is for the front side layer 19 to further include hydrophobing agent, such as wax. The front side layer 19 may comprise 1-3 wt. %, or 1-2 wt. % of the hydrophobing agent. Preferred hydrophobing agents are paraffin emulsions. An advantage with having a hydrophobing agent in layers 15, 17, 19 of the building panel 10 is that it provides the layers 15, 17, 19 with improved water repellent properties, in turn creating a more water resistant building panel 10. It may thus be beneficial to have a hydrophobing agent in the layer 15, 17, 19 in which features for increasing the water resistant properties of the building panel 10 are created. Examples of this will be described later on.

The front side layer 19 may further include colorant 19c, as described above.

The front side layer 19 may further comprise other types of additives, such as catalyst (e.g., ammonium sulphate), formaldehyde scavenger (e.g., urea), or buffer solution.

In order to even further increase the water resistant properties of the building panel 10 the density of each layer 15, 17, 19, may be adapted to different water resistant properties designed within the layers 15, 17, 19 of the building panel 10. For example, it may be desirable to, in the front side layer 19, to design water resistant features of a mechanical locking device, which will be described in more detail below, and thus, desirable to increase the density of the front side layer 19 in order to even further improve the water resistant features of such a mechanical locking device. Whereas the intermediate layer 17 may be designed to have no additional water resistant features and therefore does not need an increased density. By adapting the density of each layer, the back side layer 15, the intermediate layer 17 and the front side layer 19, it is possible to both increase the water resistant properties of the building panel 10 where it is desirable to do so and decrease the risk of the building panel 10 becoming too heavy. The weight of the building panel 10 will also depend on the thickness of each of the components of the building panel 10 but by being able to control and adapt the thickness, the density, the lignocellulosic particle sizes, the amount of binder, etc. in each of the back side layer 15, the intermediate layer 17 and the front side layer 19 the weight of the building panel 10 also becomes controllable.

The density of the building panel may be adapted to its intended use.

For a floor panel, a density of the intermediate layer 17 is less than the density of the front side layer 19 and/or the back side layer 15. A preferred density of the intermediate layer 17 may be between 700-900 kg/m³, or about 800 kg/m³. A preferred density of the front side layer 19 may be between 800-1200 kg/m³, or between 900-1100 kg/m³. In order to balance the building panel 10, it is preferred that the back side layer 15, even if it does not have any additional water resistant features designed in it, has the same density as the front side layer 19. Thus, the density of the back side layer 15 is substantially the same as the density of the front side layer 19. Thus, the density of the back side layer 15 may be between 800-1200 kg/m³, or between 900-1100 kg/m³.

In total, the density of the floor panel may be 700-1100 kg/m³.

For a wall panel, a density of the intermediate layer 17 may be between 150-400 kg/m³, or about 300 kg/m³. A preferred density of the front side layer 19 may be between 400-700 kg/m³, or between 500-600 kg/m³.

In order to balance the building panel 10, it is preferred that the back side layer 15, even if it does not have any additional water resistant features designed in it, has the same density as the front side layer 19. Thus, the density of the back side layer 15 may be substantially the same as the density of the front side layer 19. Thus, the density of the back side layer 15 may be between 400-700 kg/m³, or between 500-600 kg/m³.

In total, the density of the wall panel may be 300-600 kg/m³.

The cork particles 101 forming the front cork layer 102, such as the granulated cork material, may be applied on the carrier 6 in an amount of 100-400 g/m², for example in an amount of 150-300 g/m², such as about 200 g/m². The amount of the third mixture may be reduced by an amount corresponding to the amount of the cork particles 101 applied.

The granulated cork material may have a particle size of 0.5-4 mm. 100 wt. % of the granulated cork material may have a particle size of 0.5-4 mm. At least 80 wt. % of the granulated cork material may have a particle size of 1-3 mm. The granulated cork material may have an average particle size of 0.5-4 mm, such as 1-3 mm.

The front cork layer 102 may have a thickness of 0.5-1 mm in the direction perpendicular to the extension of the top surface 24.

The cork particles 111, such as the granulated cork material, may be applied in an amount of 100-400 g/m², for example in an amount of 150-300 g/m², such as about 200 g/m². The amount of the first mixture may be reduced by an amount corresponding to the amount of the cork particles 111 applied.

The back cork layer 112 may have a thickness of 0.5-1 mm thickness in the direction perpendicular to the extension of the top surface 24. The building panel 10 preferably has a thickness in the direction perpendicular to the extension of the top surface 24 of between 4 mm and 32 mm, between 6 mm and 15 mm, or about 10 mm.

The ratio between the thickness of the intermediate layer 17 and the total thickness of the back side layer 15 and the front side layer 19 may be between 70:30 and 30:70, or between 60:40 and 40:60.

The ratio between the thickness of the front side layer 19 and the thickness of the back side layer 15 may be between 40:60 and 60:40, or between 45:55 and 55:45. The ratio between the thickness of the front side layer 19 and the thickness of the back side layer 15 may be about 50:50. As explained above the building panel 10 may further include a pattern (not shown) in the top surface of the front side element 21 which has been created simultaneously with applying pressure and heat to form the building panel 10. The pattern may be a desirable and attractive structure or different gloss levels in the top surface 24.

FIG. 10 illustrates a top view of a building panel 10 which may for example be a floor panel, a wall panel, a ceiling panel, a furniture component, or similar. The building panel 10 has a top surface 24, which preferably is the visible surface of the building panel in an assembled state, and a bottom surface 29, which preferably is arranged parallel to and spaced apart from, by the thickness of the building panel 10, the top surface 24. The bottom surface 29 further faces away from the top surface 24. Either the back side layer 13 or, if present the back side element 11 may comprise the bottom surface 29. The top surface 24 may preferably be a decorative top surface. Either the front side layer or, if present, the front side element 21 may comprise the top surface 24.

The building panel further has a first edge portion 25, a second edge portion 26, a third edge portion 27 and a fourth edge portion 28. The second edge portion 26 is arranged opposite the first edge portion 25 and extends in a parallel direction to the first edge portion 25. The fourth edge portion 28 is arranged opposite the third edge portion 27 and extends in a parallel direction to the third edge portion 27. In the illustrated examples the first and second edge portions 25, 26 are the long edge portions of the building panel 10 and the third and fourth edges 27, 28 are the short edge portions of the building panel 10. The building panel 10 is designed to be assembled with similar or substantially identical building panels 10′, 10″ as illustrated in FIGS. 11A and 11B.

In order to assemble similar or essentially identical building panels 10, 10′, 10″ the first edge portion 25 and the second edge portion 26 of the building panel 10 are provided with a first mechanical locking device 30a, configured such that the first edge portion 25 of a building panel 10 is able to mechanically lock to a second edge portion 26 of an adjacent building panel 10′ and vice versa, i.e., the opposite first and second edge portions 25, 26 are designed to be compatible with each other. The first mechanical locking device 30a extends preferably along the entire length of the first and second edge portion 25, 26, respectively. Further, the third edge portion 27 and the fourth edge portion 28 of the building panel 10 are provided with a second mechanical locking device 30b, configured such that the third edge portion 27 of a building panel 20 is able to mechanically lock to a fourth edge portion 28 of an adjacent building panel 20″ and vice versa, i.e., the opposite third and fourth edge portions 27, 27 are designed to be compatible with each other. The second mechanical locking device 30b extends preferably along the entire length of the third and fourth edge portion 25, 26, respectively. Each mechanical locking device 30a, 30b is configured to lock adjacent building panels 10, 10′, 10″ in a horizontal and/or vertical direction, preferably in a horizontal and vertical direction, by means of a folding and/or vertical displacement. To be even more specific, the first mechanical locking device 30a, which is arranged in the first and second edge portion 25, 26 of the building panel is configured to lock adjacent building panels 10, 10′, 10″ in a direction parallel to the longitudinal extension of the third and fourth edge portions 27, 28 and in the direction perpendicular to the longitudinal extension of the third and fourth edge portion 27, 28. The other way around, the second mechanical locking device 30b, which is arranged in the third and fourth edge portion 27, 28 of the building panel is configured to lock adjacent building panels 10, 10′, 10″ in a direction parallel to the longitudinal extension of the first and second edge portion 25, 26 and in the direction perpendicular to the longitudinal extension of the first and second edge portions 25, 26. If such building panels 10, 10′, 10″ are assembled as floor panels, the parallel directions correspond to the horizontal direction and the perpendicular directions correspond to the vertical direction.

A first building panel 10 is assembled to a second building panel 10′ by means of the first mechanical locking device 30a provided along respective first and second edge portions 25, 26 of respective building panel 10, 10′. The first mechanical locking device 30a may be configured to assemble and lock adjacent building panels 10, 10′ in a horizontal and vertical direction by means of a folding displacement F, see FIG. 11A.

When the first building panel 10 is assembled with the second building panel 10′ the first building panel 10 may preferably be displaceable in the horizontal direction such that the first building panel 10 is placed in the right location for being assembled to the third building panel 10″

The first building panel 10 is then assembled to a third building panel 10″ by means of the second mechanical locking device 30b provided along respective third and fourth edge portions 27, 28 of respective building panel 10, 10″. The second mechanical locking device 30b may be configured to assemble and lock adjacent building panels 10, 10″ in a horizontal and vertical direction by means of a vertical displacement, such as vertical folding.

In an alternative installation (not shown) the first building panel may firstly be assembled with the third building panel, along the short side edge, and then assembled to the second building panel, along the long side edge.

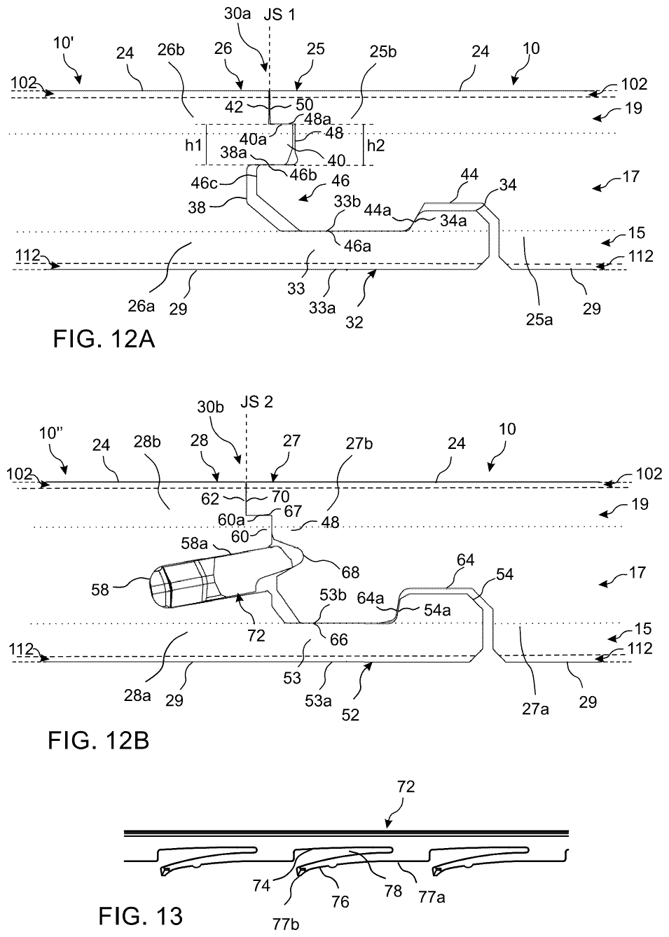

In the assembled position, as is illustrated in FIG. 11B, an upper edge area 25b of the first edge portion 25 of the first building panel 10 and an upper edge area 26b of the second edge portion 26 of the second panel 10′ are juxtaposed to form a joint seal JS1 between the first and second building panel 10, 10′. Further, in the assembled position, an upper edge area 27b of the third edge portion 27 of the first building panel 10 and an upper edge area 28b of the fourth edge portion 28 of the third building panel 10″ are juxtaposed to form a joint seal JS2 between the first and third building panel 10, 10″. These two join seals JS1, JS2 are illustrated in more detail in FIGS. 12A and 12B.

The detailed description of embodiments below is based on the assembling illustrated in FIG. 11B, i.e., with a first, a second and a third building panel 10, 10′, 10″. Since all building panels 10, 10′, 10″ are similar or essentially identical, all features of the mechanical locking device are present on each building panel 10, 10′, 10″.

FIG. 12A illustrate the first mechanical locking device 30a in the assembled state of two adjacent building panels 10, 10′. Preferably, all features of the first mechanical locking device 30a are integrally formed in the first and second edge portion 25, 26, respectively.

The first mechanical locking device 30a comprises along the second edge portion 26 a locking strip 32. The locking strip 32 is arranged at a lower edge area 26a of the edge portion 26, projecting outwards from the lower edge are 26a. The locking strip 32 may be configured to be angularly displaced during the folding displacement.

The locking strip 32 includes, at the outmost end of the locking strip 32, a locking element 34. The locking element 34 is configured to be received in a locking groove 44 arranged in a lower edge area 25a of the first edge portion 25 of an adjacent building panel, by means of the folding displacement.

The locking strip 32 has an elongated shape with the locking element 34 arranged at the outermost end. Between the innermost end of the locking strip 32 and the locking element 34 the locking strip 32 has an elongated body 33. The elongated body 33 has a lower surface 33a facing the bottom surface 29 of the building panel and an upper surface 33b facing in the opposite direction, i.e., towards the top surface 24 of the building panel.

The upper surface 33b is preferably plane. The lower surface 33a may be flush with the bottom surface 29 of the building panel.

The upper surface 33b, in the assembled position, extends preferably in the same direction as a lower surface 46a of a locking tongue 46 in the first edge portion 25 of an adjacent building panel, pushing on the upper surface 33b. The upper surface 33b and the lower surface 46a are preferably planar. The upper surface 33b of the elongated body 33 of the locking strip 32 is configured to, in the assembled state, cooperate and preferably at least partly be in contact with the lower surface 46a of the locking tongue 46.

The locking element 34 of the locking strip 32 includes a front locking surface 34a. The front locking surface 34a is arranged at the innermost end of the locking element 34. The upper surface 33b of the elongated body 33 merges into the front locking surface 34a of the locking element 34. The front locking surface 34a of the locking element 34 is configured to, in the assembled state, cooperate and preferably at least partly be in contact with a front wall 44a of a locking groove 44 in the first edge portion 25. The front locking surface 34a of the locking element 34 and the front wall 44a of the locking groove 44 are configured to lock two adjacent building panels in at least a direction parallel to the longitudinal extension of the third and fourth edge portion 27, 28.

The elongated body 33 may be configured to be bendable, to the extent that a portion of the elongated body 33 during installation of two building panels 10, 10′, 10″ may be pushed and displaced downwards.

In order to reduce the risk of affecting the properties of the locking strip 32, e.g., that the elongated body 33 is supposed to flex to a degree during the assembling process it is preferred to control and adapt in which layer 15, 17, 19 of the multi-layered substrate 14 the locking strip 32 is located. It is preferred that most of the locking strip 32 is located in either the back side layer 15 or the intermediate layer 17. In a preferred embodiment, most of the locking strip 32, i.e., at least 60%, or at least 80% of the locking strip 32, is designed in the back side layer 15. Of course, the position of the locking strip 32 may be adjusted and adapted to the back side layer 15, e.g., due to a preferred thickness of the back side layer 15. Vice versa, the thickness of the back side layer 15 may be adjusted and adapted to the position of the locking strip 32. This is one of the main advantages with an inventive concept of this disclosure, to be able to adapt and control all features of the building panel without any addition preprocessing of the components of the building panel.

The first mechanical locking device 30a, in the second edge portion 26, further includes a tongue groove 38. The tongue groove 38 is arranged above the locking strip 32 at the innermost end of the locking strip 32 and extends inwards into the second edge portion 26. The tongue groove 38 is configured and shaped to receive a locking tongue 46 in the first edge portion 25 of the adjacent building panel. In the assembled position, the tongue groove 38 and the locking tongue 46 are configured to cooperate and lock two adjacent building panels in at least a direction perpendicular to the longitudinal extension of the third and fourth edge portion 27, 28. The tongue groove 38 and the locking tongue 46 may further be configured to lock two adjacent building panels in the direction parallel to the longitudinal extension of the third and fourth edge portion 27, 28.

An upper wall 38a of the tongue groove 38 may be configured to cooperate and preferably be in contact with an upper surface 46b of the locking tongue 46 in the first edge portion 25 of an adjacent building panel. The upper wall 38a may be configured to lock the locking tongue 38 in the direction perpendicular to the longitudinal extension of the third and fourth edge portion 27, 28.

The first mechanical locking device 30a, in the second edge portion 26, further includes a front side tongue 40. The front side tongue 40 is arranged in an upper edge area 26b of the second edge portion 26 and extends outwards away from the second edge portion 26. The front side tongue 40 is arranged above the tongue groove 38.

The front side tongue 40 is configured and shaped to be received in a front side tongue groove 48 in the first edge portion 25 of the adjacent building panel. In the assembled position, the front side tongue 28 and the front side tongue groove 48 are configured to lock two adjacent building panels in the direction perpendicular, and preferably also parallel, to the longitudinal extension of the third and fourth edge portion 27, 28.

An upper surface 40a, extending in the direction parallel to the longitudinal extension of the third and fourth edge portion 27, 28, of the front side tongue 40 is configured to cooperate and preferably be in contact with an upper wall 48a of the front side tongue groove 48. The upper wall 48a of the front side tongue groove 48 is configured to lock the front side tongue 40 in the direction perpendicular to the longitudinal extension of the third and fourth edge portion 27, 28.

It may be preferred to have a height h1 of the front side tongue 40 of between 0.5 and 2.5 mm. It is preferred for the height h1 of the front side tongue 40 to be greater than the height h2 of the front side tongue groove 48. The difference between the height h1 of the front side tongue 40 and the height h2 of the front side tongue groove 48 is in the range of 0.01 to 0.5 mm, preferably 0.01 to 0.25 mm, more preferably 0.01 to 0.15 mm.

When the front side tongue 40 is arranged in the front side tongue groove 48, in the assembled position, the front side tongue 40 and the front side tongue groove 48 creates a tight seal. This is advantageous since the tight seal obstruct e.g., water, or other fluids, to penetrate further down into the mechanical locking device 30a. It is especially beneficial if the upper surface 40a of the front side tongue 40 creates a tight seal against the upper wall 48a of the front side tongue groove 48 since it is where the fluids are prone to spread out into the rest of the mechanical locking device 30a and the rest of the building panel.

In order to increase the water resistant properties even further it may be desirable to design and position at least the upper surface 40a of the front side tongue 40 in the above described front side layer 19, see the upper dotted lines in FIG. 12A. The features of the front side layer 19, as described above, are controlled such that they contribute to the increased water resistant properties of the mechanical locking device 30a and the building panel 10. This is achieved for example by having a higher density, lignocellulosic particles with a smaller size than for example in the intermediate layer 17, a higher binder content or adding a hydrophobing agent in the front side layer 19. Of course, the position of the upper surface 40a of the front side tongue 40 may be adjusted and adapted to the front side layer 19, e.g., due to a preferred thickness of the front side layer 19. Vice versa, the thickness of the front side layer 19 may be adjusted and adapted to the position of the upper surface 40a of the front side tongue 40.

Further, at least the upper surface 40a of the front side tongue 40 may be positioned in the front cork layer 102, as illustrated by the dashed line in FIG. 12A. At least active locking surfaces of the first mechanical locking device 30a, such as cooperating locking surfaces of the first mechanical locking device 30a, are preferably arranged outside the front cork layer 102, and outside the back cork layer 112, if present.

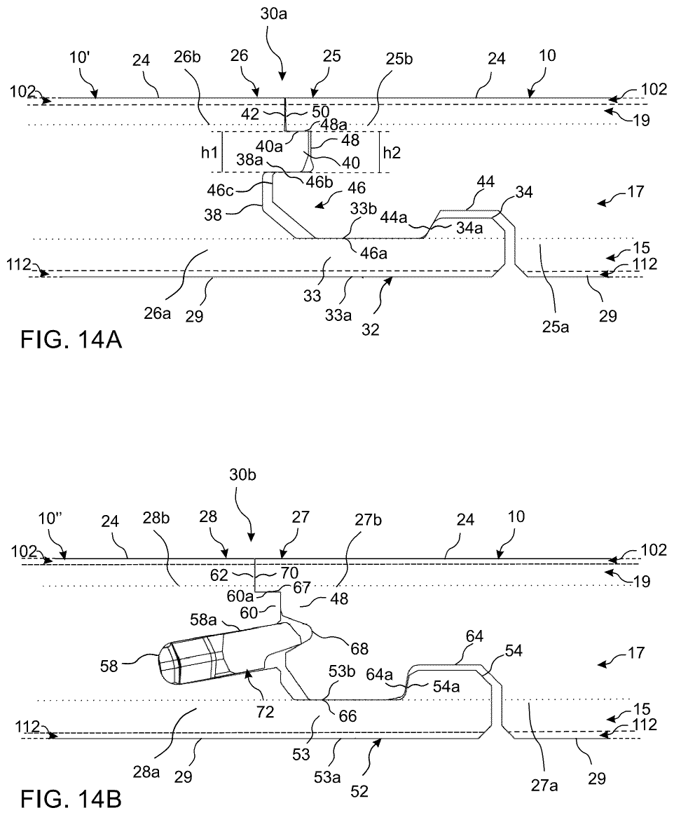

Alternatively, in one embodiment, in order to increase the water resistant properties even further it may be desirable to design and position the front side tongue 40 in the intermediate layer 17, see the upper dotted line in FIG. 14A, in order to be able to achieve a controlled swelling of at least the upper surface 40a of the front side tongue 40, when fluid penetrates into the building panel. A controlled swelling of at least the upper surface 40a can provide a tight seal when the front side tongue 40 is arranged in the front side tongue groove 48 and in turn provide increased water resistant properties and prevent fluid from penetrate further into the building panel. One of the main advantages with an inventive concept of this disclosure, is to be able to adapt and control all features of the building panel without any additional preprocessing of the components of the building panel.

At least the upper surface 40a of the front side tongue 40 may be positioned in the front cork layer 102, as illustrated by the dashed line in FIG. 14A.

At least active locking surfaces of the first mechanical locking device 30a, such as cooperating locking surfaces of the first mechanical locking device 30a, are preferably arranged outside the front cork layer 102, and outside the back cork layer 112, if present.

In all other aspects, the disclosure in FIG. 14A corresponds to the disclosure in FIG. 12A.

At the upper edge area 26b of the second edge portion 26, above the front side tongue 40 there is provided a locking surface 42 extending perpendicular to the upper surface 40a of the front side tongue 40, i.e., extending in the direction perpendicular to the longitudinal extension of the third and fourth edge portion 27, 28. At the upper edge area 25b of the opposite first edge portion 25 there is provided an opposite locking surface 50, extending parallel to the locking surface 42 of the second edge portion 26, i.e., extending in the direction perpendicular to the longitudinal extension of the third and fourth edge portion 27, 28. The locking surface 42 of the second edge portion 26 is configured to cooperate, and preferably be in contact with the locking surface 50 of the first edge portion 25, in the assembled position, as illustrated in FIG. 12A. Together, the locking surface 42 of the second edge portion 26 and the locking surface 50 of the first edge portion 25 form the joint seal JS1. The seal between the two locking surfaces 42, 50 may preferably have a pretension, such that there is a force between the two locking surfaces 42, 50 working towards each other. This pretension may decrease the risk of fluids entering into the mechanical locking device 30a ever further.

Although many of the features of the first mechanical locking device 30a in the first edge portion 25 has been described above, additional features are now described in more detail.

The first mechanical locking device 30a in the first edge portion 25 includes the locking groove 44. The locking groove 44 is arranged in the lower edge area 25a of the first edge portion 25 and extends in a direction upwards into and away from the bottom surface 29 of the building panel.

The locking groove 44 is configured and shaped to receive the locking element 34 of the locking strip 32 of the adjacent building panel. In the assembled position, the locking groove 44 and the locking element 34 are configured to lock two adjacent building panels in at least the direction parallel to the longitudinal extension of the third and fourth edge portion 27, 28. In order to do so the locking groove 44, in the illustrated embodiments, includes a front wall 44a. The front wall 44a is configured to, in the assembled position, cooperate and preferably at least partly be in contact with the front locking surface 34a of the locking element 34 of the adjacent building panel.

Further, the first mechanical locking device 30a in the first edge portion 25 includes a locking tongue 46. The locking tongue 46 extends outwards, in a direction parallel to the longitudinal extension of the third and fourth edge portion 27, 28, away from the first edge portion 25.

The locking tongue 46 is at least partly configured and shaped to be received in the tongue groove 38 in the second edge portion 26 of the adjacent building panel, as explained above.

The locking tongue 46 preferably has an elongated shape where at least an outermost portion 46c is received in the tongue groove 38, in the assembled position. The locking tongue 46 and the outermost portion 46c has an upper surface 46b which is configured to cooperate and preferably be in contact with the upper wall 38a of the tongue groove 38 of the adjacent building panel. The upper wall 38a and the upper surface 46b are configured to lock two adjacent building panels in the direction perpendicular to the longitudinal extension of the third and fourth edge portion 27, 28.

As briefly described above, the locking tongue 46 further has a lower surface 46a. The lower surface 46a may be configured to cooperate and even be in contact with the upper surface 33a of the elongated body 33 of the locking strip 32, in the assembled state. For example, during installation, the lower surface 46a may be configured to displace, and preferably push on, the upper surface 33a of the elongated body 33 of the locking strip 32. As explained above, the locking strip may be flexible allowing the lower surface 46a of the locking tongue 46 to push the locking strip 32 downwards. This movement may increase the preferred pretension in the two parallel locking surfaces 42, 50 in the upper edge area 25b, 26b of respective first and second edge portion 25, 26 of adjacent building panels.

At least portions of the locking strip 32 may be located in the back cork layer 112, as visible by the dashed line in FIG. 12A.

The first mechanical locking device 30a in the first edge portion 25 may also include a front side tongue groove 48. The front side tongue groove 48 is arranged above the locking tongue 46 and extends inwards, into the building panel.

The front side tongue groove 48 is configured and shaped to receive the front side tongue 40 in the second edge portion 26 of the adjacent building panel. In the assembled position, the front side tongue groove 48 and the front side tongue 40 are configured to lock two adjacent building panels in the direction perpendicular to the longitudinal extension of the third and fourth edge portion 27, 28.

As explained above, in order to cause a tight seal, it may be preferred to have a height h1 of the front side tongue 40 of between 0.5 and 2.5 mm. It is preferred for the height h1 of the front side tongue 40 to be greater than the height h2 of the front side tongue groove 48. Thus, as the front side tongue 40 is arranged in the front side tongue groove 48, in the assembled position, the front side tongue 40 and the front side tongue groove 48 creates a tight seal. This is advantageous since the tight seal obstruct e.g., water, or other fluids, to penetrate further down into the mechanical locking device 30a.

Thus, when the front side tongue 40 is arranged in the front side tongue groove 48, in the assembled position, the front side tongue 40 and the front side tongue groove 48 creates a tight seal. This is advantageous since the tight seal obstruct e.g., water, or other fluids, to penetrate further down into the mechanical locking device 30a. It is especially beneficial if the upper surface 40a of the front side tongue 40 creates a tight seal against the upper wall 48a of the front side tongue groove 48 since it is where the fluids are prone to spread out into the rest of the mechanical locking device 30a and the rest of the building panel.

At the upper edge area 25b of the first edge portion 25, above the front side tongue groove 48 there is provided a locking surface 50 extending perpendicular to the upper wall 48a of the front side tongue groove 48, i.e., extending in the direction perpendicular to the longitudinal extension of the third and fourth edge portion 27, 28. At the upper edge area 26b of the opposite second edge portion 26 there is provided the opposite locking surface 42, extending parallel to the locking surface 50 of the first edge portion 25, i.e., extending in the direction perpendicular to the longitudinal extension of the third and fourth edge portion 27, 28. The locking surface 50 of the first edge portion 25 is configured to cooperate, and preferably be in contact with the locking surface 42 of the second edge portion 26, in the assembled position, as illustrated in FIG. 12A. Together, the locking surface 50 of the first edge portion 25 and the locking surface 42 of the second edge portion 26 form the joint seal JS1. The seal between the two locking surfaces 42, 50 may preferably have a pretension, such that there is a force between the two locking surfaces 42, 50 working towards each other. This pretension may decrease the risk of fluids entering into the mechanical locking device 30a ever further. Such a pretension between the two locking surfaces 42, 50 may, in an environment with normal humidity of two building panels each being 100 mm long, be between 2-100N, or between 5-80N.

FIG. 12B illustrate the second mechanical locking device 30b in the assembled state. Preferably, all features, with the exception of a displaceable locking tongue 72, of the second mechanical locking device 30b are integrally formed in the third and fourth edge portion 27, 28, respectively. Much is similar to the first mechanical locking device 30a and its embodiments. The second mechanical locking device 30b is configured to assemble and lock adjacent building panels 10, 10′, 10″ in a direction parallel and perpendicular to the longitudinal extension of the first and second edge portion 25, 26 of the building panel, by means of the vertical displacement.

The second mechanical locking device 30b includes along the fourth edge portion 28 a locking strip 52, preferably integrally formed in the fourth edge portion 28. The locking strip 52 is arranged at a lower edge area 28a of the fourth edge portion 28, projecting outwards from the lower edge area 28a. The locking strip 52 may be configured to be angularly displaced during the vertical displacement.

The locking strip 52 includes, at the outmost end of the locking strip 52, a locking element 54. The locking element 54 is configured to be received in a locking groove 64 arranged in a lower edge area 27a of the third edge portion 27 of an adjacent building panel, by means of the vertical displacement.

The locking strip 52 has an elongated shape with the locking element 54 arranged at the outermost end. Between the innermost end of the locking strip 52 and the locking element 54 the locking strip 52 has an elongated body 53. The elongated body 53 has a lower surface 53a facing the bottom surface 29 of the building panel and an upper surface 53b facing in the opposite direction, i.e., towards the top surface 24 of the building panel. The upper surface 53b, in the assembled position, extends preferably in the same direction as a lower surface 66 in the lower edge area 27a of the third edge portion 27 of an adjacent building panel, pushing on the upper surface 53b. The upper surface 53b and the lower surface 66 are preferably planar. The upper surface 53b of the elongated body 53 of the locking strip 52 is configured to, in the assembled state, cooperate and preferably at least partly be in contact with the lower surface 66 in the lower edge area 27a of the third edge portion 27.

The locking element 54 of the locking strip 52 includes a front locking surface 54a. The front locking surface 54a is arranged at the innermost end of the locking element 54. The upper surface 53b of the elongated body 53 merges into the front locking surface 54a of the locking element 54. The front locking surface 56 of the locking element 54 is configured to, in the assembled state, cooperate and preferably at least partly be in contact with a front wall 64a of a locking groove 64 in the third edge portion 27. The front locking surface 54a of the locking element 54 and the front wall 64a of the locking groove 64 are configured to lock two adjacent building panels in at least a direction parallel to the longitudinal extension of the first and second edge portion 25, 26.

The elongated body 53 may be configured to be bendable, to the extent that a portion of the elongated body 53 during installation of two building panels 10, 10″ may be pushed and displaced downwards.

In order to reduce the risk of affecting the properties of the locking strip 52, e.g., that the elongated body 53 is supposed to flex to a degree during the assembling process it is preferred to control and adapt in which layer 15, 17, 19 of the multi-layered substrate 14 the locking strip 52 is located. It is preferred that most of the locking strip 52 is located in either the back side layer 15 or the intermediate layer 17. In a preferred embodiment, most of the locking strip 52, i.e., at least 60%, or at least 80% of the locking strip 52, is designed in the back side layer 15. Of course, the position of the locking strip 52 may be adjusted and adapted to the back side layer 15, e.g., due to a preferred thickness of the back side layer 15. Vice versa, the thickness of the back side layer 15 may be adjusted and adapted to the position of the locking strip 52. This is one of the main advantages with an inventive concept of this disclosure, to be able to adapt and control all features of the building panel without any addition preprocessing of the components of the building panel. At least portions of the locking strip 52 may be positioned in the back cork layer 112, as illustrated by the dashed line in FIG. 12B.

The second mechanical locking device 30b, in the fourth edge portion 28, further includes a displaceable tongue groove 58. The displaceable tongue groove 58 is arranged above the locking strip 52 at the innermost end of the locking strip 52, and extends inwards, preferably angled, into the fourth edge portion 27.

The displaceable tongue groove 58 is configured and shaped to receive a displaceable locking tongue 72. The displaceable locking tongue 72, when arranged in the displaceable tongue groove 58, is configured to lock two adjacent building panels in at least a direction perpendicular to the longitudinal extension of the first and second edge portion 25, 26, when engaged with a displaceable tongue groove 68 in the third edge portion 27 of the adjacent building panel.

The displaceable locking tongue 72 may be a separate member and comprise the same or a different material than the building panel. The displaceable locking tongue 72 may be made of a polymer-based material. The displaceable locking tongue 72 is described in more detail below with reference to FIG. 13

The first mechanical locking device 30b, in the fourth edge portion 28, further includes a front side tongue 60. The front side tongue 60 is arranged in the upper edge area 28b of the fourth edge portion 28 and extends outwards away from the fourth edge portion 28. The front side tongue 60 is arranged above the displaceable tongue groove 58.

The front side tongue 60 has an upper surface 60a which is configured to cooperate and preferably be in contact with a lower surface 67 arranged in the upper edge area 27b of the third edge portion 27 of the adjacent building panel. The lower surface 67 of the third edge portion 27 is configured to lock the upper surface 60a of the front side tongue 60 in the direction perpendicular to the longitudinal extension of the first and second edge portion 25, 26.

When the upper surface 60a of the front side tongue 60 is locked against the lower surface 67 of the third edge portion 27 of the adjacent building panel, the upper surface 60a and the lower surface 67 creates a tight seal. This is advantageous since the tight seal obstruct e.g., water, or other fluids, to penetrate further down into the mechanical locking device 30a.

In order to increase the water resistant properties even further it may be desirable to design and position at least the upper surface 60a of the front side tongue 60 in the above described front side layer 19, see the upper dotted line in FIG. 12B. The features of the front side layer 19, as described above, are controlled such that they contribute to the increased water resistant properties of the mechanical locking device 30b and the building panel 10. This is achieved for example by having a higher density, lignocellulosic particles with a smaller size than for example in the intermediate layer 17, a higher binder content or adding a hydrophobing agent in the front side layer 19. Of course, the position of the upper surface 60a of the front side tongue 60 may be adjusted and adapted to the front side layer 19, e.g., due to a preferred thickness of the front side layer 19. Vice versa, the thickness of the front side layer 19 may be adjusted and adapted to the position of the upper surface 60a of the front side tongue 60.

Further, at least the upper surface 60a of the front side tongue 60 may be positioned in the front cork layer 102, as illustrated by the dashed line in FIG. 12B.

At least active locking surfaces of the first mechanical locking device 30a, such as cooperating locking surfaces of the first mechanical locking device 30a, are preferably arranged outside the front cork layer 102, and outside the back cork layer 112, if present.

Alternatively, in one embodiment, in order to increase the water resistant properties further it may be desirable to design and position the front side tongue 60 in the intermediate layer 17, see the upper dotted lines in FIG. 14B, in order to be able to achieve a controlled swelling of at least the upper surface 60a of the front side tongue 60, when fluid penetrates into the building panel. A controlled swelling of at least the upper surface 60a can provide a tight seal of the front side tongue 60 against the lower surface 67 and in turn provide increased water resistant properties and prevent fluid from penetrate further into the building panel. One of the main advantages with an inventive concept of this disclosure, to be able to adapt and control all features of the building panel without any addition preprocessing of the components of the building panel.

At least the upper surface 60a of the front side tongue 60 may be positioned in the front cork layer 102, as illustrated by the dashed line in FIG. 14B.

At least active locking surfaces of the first mechanical locking device 30a, such as cooperating locking surfaces of the first mechanical locking device 30a, are preferably arranged outside the front cork layer 102, and outside the back cork layer 112, if present.

In all other aspects, the disclosure in FIG. 14B corresponds to the disclosure in FIG. 14A.

At the upper edge area 28b of the fourth edge portion 28 above the upper surface 60a of the front side tongue 60 there is provided a locking surface 62 extending perpendicular to the upper surface 60a of the front side tongue 60, i.e., extending in the direction perpendicular to the longitudinal extension of the first and second edge portion 25, 26. At the upper edge area 27b of the opposite third edge portion 27 of the adjacent building panel 1 there is provided an opposite locking surface 70 extending parallel to the locking surface 62 of the fourth edge portion 28, i.e., extending in the direction perpendicular to the longitudinal extension of the first and second edge portion 25, 26. The locking surface 62 of the fourth edge portion 28 is configured to cooperate, and preferably be in contact with the locking surface 70 of the third edge portion 27, in the assembled position, as illustrated in FIG. 12B. Together, the locking surface 62 of the fourth edge portion 28 and the locking surface 70 of the third edge portion 27 form the joint seal JS2. The seal between the two locking surfaces 62, 70 may preferably have a pretension, such that there is a force between the two locking surfaces 62, 70 working towards each other. This pretension may decrease the risk of fluids entering into the mechanical locking device 30b ever further.

Although many of the features of the second mechanical locking device 30b in the third edge portion 27 has been described above, additional features are now described in more detail.

The second mechanical locking device 30b in the third edge portion 27 includes the locking groove 64. The locking groove 64 is arranged in the lower edge area 27a of the third edge portion 27 and extends in a direction upwards into and away from the bottom surface 29 of the building panel.

The locking groove 64 is configured and shaped to receive the locking element 54 of the locking strip 52 of the adjacent building panel. In the assembled position, the locking groove 64 and the locking element 54 are configured to lock two adjacent building panels in at least the direction parallel to the longitudinal extension of the first and second edge portion 25, 26. In order to do so the locking groove 64, in the illustrated embodiments, includes a front wall 64a. The front wall 64a is configured to, in the assembled position, cooperate and preferably at least partly be in contact with the front locking surface 54a of the locking element 54 of the adjacent building panel.

The second mechanical locking device 30b in the third edge portion 27 further preferably has the lower surface 66 as mentioned above. The lower surface 66 is arranged in the lower edge area 27a of the third edge portion 27 of the building panel. The lower surface 66 may be configured to cooperate and even be in contact with the upper surface 53b of the elongated body 53 of the locking strip 52, in the assembled state. For example, during installation, the lower surface 66 may be configured to displace, and preferably push on, the upper surface 53a of the elongated body 53. As explained above, the locking strip may be flexible allowing the lower surface 66 to push the locking strip 52 downwards. This movement may increase the preferred pretension in the two parallel locking surfaces 62, 70 in the upper edge area 27b, 28b of respective third and fourth edge portion 27, 28 of adjacent building panels.

The second mechanical locking device 30b in the third edge portion 27 there is also provided a displaceable tongue groove 68. The displaceable tongue groove 68 is arranged below the lower surface 67 of the upper edge area 27b and above the lower surface 66 of the lower edge area 27a. The displaceable tongue groove 68 is shaped and configured to receive the displaceable locking tongue 72, explained in more detail below. The displaceable tongue groove 68 extends along the longitudinal extension of the third edge portion 27 of the building panel.

The displaceable tongue groove 68 is configured to, together with the displaceable locking tongue 72, lock two adjacent building panels in the direction perpendicular to the longitudinal extension of the first and second edge portion 25, 26.

Above the displaceable tongue groove 68 there is provided the lower surface 67 of the upper edge area 27b of the third edge portion 27. The lower surface 67 extends in a direction parallel to the longitudinal extension of the first and second edge portion 25, 26. The lower surface 67 faces down towards the bottom surface 29 of the building panel. The lower surface 67 is configured to, in the direction perpendicular to the longitudinal extension of the first and second edge portion 25, 26, lock the upper surface 60a of the front side tongue 60 in the assembled position. The lower surface 67 is configured to cooperate and preferably be in contact with the upper surface 60a of the front side tongue 60 in the assembled position.

At the upper edge area 27b of the third edge portion 27, above the lower surface 67 there is provided a locking surface 70 extending perpendicular to the lower surface 67, i.e., extending in the direction perpendicular to the longitudinal extension of the first and second edge portion 25, 26. At the upper edge area 28b of the opposite fourth edge portion 28 there is provided the opposite locking surface 62, extending parallel to the locking surface 70 of the third edge portion 27, i.e., extending in the direction perpendicular to the longitudinal extension of the first and second edge portion 25, 26. The locking surface 70 of the third edge portion 27 is configured to cooperate, and preferably be in contact with the locking surface 62 of the fourth edge portion 28, in the assembled position, as illustrated in FIG. 12B. Together, the locking surface 70 of the third edge portion 27 and the locking surface 62 of the fourth edge portion 28 form the joint seal JS2. The seal between the two locking surfaces 62, 70 may preferably have a pretension, such that there is a force between the two locking surfaces 62, 70 working towards each other. This pretension may decrease the risk of fluids entering into the mechanical locking device 30b ever further. Such a pretension between the two locking surfaces 62, 70 may, in an environment with normal humidity of two building panels each being 100 mm long, be between 2-100N, or between 5-80N.

Illustrated in FIG. 13 the displaceable locking tongue 72 has a longitudinal base portion 74 which continuously extends along the length of the displaceable locking tongue 72. Along the base portion 74 several elongated flexible or bendable parts 76 are provided. The elongated bendable parts 76 are integrally formed with the base portion 74 at a first end 77a. The opposite second end 77b of the bendable part 76 is configured to move freely between a resting position and an assembled position.

In the resting position, as illustrated in FIG. 13, the elongated bendable parts 76 extend away from the base portion 74, with the second end 77b farthest away from the base portion 74. Between the elongated bendable part 76 and the base portion 74 there is provided a slot, or a gap 78, in the resting position. The bendable part 76 may bend downwards in the slot 78 towards the base portion 74. In an assembled position the bendable parts 76 are bent into the slot 78.

The displaceable locking tongue 72 is configured to be received in the displaceable tongue groove 58 in the fourth edge portion 28 and in the displaceable tongue groove 68 in the third edge portion 27, as illustrated in FIG. 12B.

Before assembling the adjacent building panels 10, 10″ the displaceable locking tongue 72 is arranged in the displaceable tongue groove 58 in the fourth edge portion 28, with the bendable parts 76 facing into the displaceable tongue groove 58 and the longitudinal base portion 74 arranged just outside the displaceable tongue groove 58, facing the building panel to be assembled.

During installation, the building panel 10 is vertically pushed down into the adjacent building panel 10″, where the building panel 10 pushes on the base portion 74, forcing the bendable parts 76 to be displaced into the slot 78 towards the base portion 74, allowing the building panel 10 to continue down. When the building panel 10 is in the assembled position the longitudinal base portion 74 of the displaceable locking tongue 72 snaps into the displaceable tongue groove 68 of the third edge portion 27, locking the two building panels 10, 10″ in the horizontal and vertical direction.

### Example: Cork Layer

Approximately 200 g/m² of granulated cork material was applied on a conveyor belt to form a back cork layer. 100 wt. % of the granulated cork material have a particle size of 0.5-4 mm. At least 80 wt. % of the granulated cork material have a particle size of 1-3 mm. The first mixture was applied in an amount of 20 wt. %, or about 1.9 kg/m², forming the back side layer. The second mixture was applied in an amount of 60 wt. %, or about 5.6 kg/m², forming the intermediate layer. The third mixture was applied in an amount of 20 wt. %, or about 1.9 kg/m², forming the front side layer. The sum of the first mixture, the second mixture, and the third mixture applied forms 100 wt. %. Approximately 200 g/m² of granulated cork material was applied on the front side layer to form a front cork layer. 100 wt. % of the granulated cork material have a particle size of 0.5-4 mm. At least 80 wt. % of the granulated cork material have a particle size of 1-3 mm.

The second mixture comprised wood particles (mixture of 70 wt. % oak and 30 wt. %, spruce in the size of 0.6-1.25 mm) which were mixed with 10 wt. %, MUF-resin and 1.5 wt. %, hydrophobing agent (paraffin emulsion). The first mixture and the third mixture both comprised wood particles (mixture of 70 wt. % oak and 30 wt. % spruce in the size of 0.315-0.6 mm) which were mixed with 20 wt. %, MUF-resin and 1.5 wt. %, hydrophobing agent (paraffin emulsion). Note: as common in wood industry, the amounts are calculated on dry weight, with the amount of bone-dry wood=100% as base.

The multilayered substrate was pressed in a single-opening lab press (500×500 mm) at 180° C. with a pressing time factor of 12 s/mm to a 10 mm five-layered building panel, including the front cork layer and the back cork layer.

The resulting building panel had a density of 595 kg/m³.

Finally, although the disclosure has been described above with reference to specific embodiments, it is not intended to be limited to the specific form set forth herein. Other embodiments than the specific above are equally possible and all embodiments may be used separately or in combinations. Angles, dimensions, rounded parts, spaces between surfaces, etc. are only examples and may be adjusted within the basic principles of the disclosure.

### Items

1. A method of producing a building panel (10), such as a floor panel, wall panel, or furniture component, comprising:
applying a back side layer (15) comprising a first mixture of at least lignocellulosic particles and a binder,
applying an intermediate layer (17) comprising a second mixture of at least lignocellulosic particles and a binder, on the back side layer (15),
applying a front side layer (19) comprising a third mixture of at least lignocellulosic particles and a binder, on the intermediate layer (17),
applying a front cork layer (102) by applying cork particles (101) on the front side layer (19) prior to applying pressure and heat, and
applying pressure and heat to the back side layer (15), the intermediate layer (17), the front side layer (19), and the front cork layer (102), thereby forming the building panel (10).

2. The method according to item 1, wherein an average particle size in the second mixture is greater than an average particle size in the first and/or third mixture.

3. The method according to item 1 or 2, wherein at least 50% of the lignocellulosic particles in the second mixture has an aspect ratio of between 1:1 and 30:1.

4. The method according to item 1 or 2, wherein the cork particles (101) are applied on the front side layer (19) as granulated cork material.

5. The method according to any one of the preceding items, wherein the cork particles (101) are applied on the front side layer (19) without adding any binder.

6. The method according to any one of the preceding items, wherein the front cork layer (102) consists of the cork particles (101) prior to applying pressure and heat.

7. The method according to any one of the preceding items, wherein a surface of the front cork layer (102) opposite the front side layer (19) is substantially free from added binder after applying pressure and heat.

8 The method according to any one of the preceding items, wherein the front cork layer (102) is attached to the front side layer (19) by the binder of the third mixture.

9 The method according to any one of the preceding items, wherein the cork particles (101) are bonded to each when pressure and heat is applied at least partly by natural resins of the cork particles (101).

10. The method according to any one of the preceding items, wherein the cork particles (101) are bonded to each other when pressure and heat is applied at least partly by the binder of the third mixture.

11. The method according to any one of the preceding items, wherein the cork particles (101) are bonded to the front side layer (19) at least partly by the binder of the third mixture.

12. The method according to any one of the preceding items, a thickness of the front cork layer (102) is 0.5-1 mm after applying pressure and heat.

13. The method according to any one of the preceding items, wherein cork particles (101) from the front cork layer (102) and lignocellulosic particles from the third mixture are mixed, at least in a border area (103) between the front cork layer (102) and the front side layer (19) when pressure and heat is applied.

14. The method according to any one of the preceding items, further comprising applying a front side element (21) on the front cork layer (102) prior to applying pressure and heat, wherein the front side element (21) is configured to be attached to the front cork layer (102) when pressure and heat is applied to form the building panel (10).

15. The method according to item 14, wherein the front side element (21) is chosen from a group consisting of: a wood veneer element, a paper sheet, a resin impregnated paper sheet, a polymer-based sheet, a prefabricated powder-based sheet, or a powder layer comprising wood fibres and binder.

16. The method according to any one of the preceding items, further comprising applying a back cork layer (112) by applying cork particles (111) on a carrier (6), and applying the back side layer (15) on the back cork layer (112).

17. The method according to item 16, wherein the cork particles (111) are applied on the carrier (6) as granulated cork material.

18. The method according to any one of the preceding items, wherein lignocellulosic particles from the second mixture and lignocellulosic particles from the third mixture are mixed, at least in a border area (18b) between the intermediate layer (17) and the front side layer (19).

19. The method according to any one of the preceding items, wherein lignocellulosic particles from the second mixture and lignocellulosic particles from the first mixture are mixed, at least in a border area (18a) between the intermediate layer (17) and the back side layer (15).

20. The method according to any one of the preceding items, wherein at least 50% of the lignocellulosic particles in the first and/or third mixture has an aspect ratio of between 1:1 and 30:1.

21. The method according to any one of the preceding items, wherein the ratio between the amount of the applied second mixture and the total amount of the applied first and third mixture is between 80:20 and 20:80, or between 70:30 and 30:70, or between 60:40 and 40:60.

22. The method according to any one of the preceding items, wherein the ratio between the amount of the applied first mixture and the amount of the applied third mixture is between 40:60 and 60:40, or between 45:55 and 55:45, or about 50:50.

23. The method according to any one of the preceding items, wherein the third mixture and/or the first mixture comprises an amount of binder between 3 wt. % and 35 wt. %, or between 10 wt. % and 25 wt. %.

24. The method according to any one of the preceding items further comprising applying a front side element (21) on the front cork layer (102) prior to applying pressure and heat to form said panel, wherein the front cork layer (102) is configured to attach to the front side element (21) when pressure and heat is applied to form said panel.

25. The method according to item 24, wherein the front side element (21) is chosen from a group consisting of: a paper sheet, a resin impregnated paper sheet, a polymer-based sheet, a prefabricated powder-based sheet, or a powder layer comprising wood fibres and binder.

26. The method according to item 25, wherein the front side element (21) is a wood veneer element.

27. The method according to item 26, wherein the front cork layer (102) is configured to penetrate into open features (22), such as cracks, holes, or pores, of the wood veneer (21) and at least partly fill such open features (22) when pressure and heat is applied.

28. The method according to any one of the preceding items, wherein the third mixture further comprises colorant, such as pigment, dye, or chemical staining agent.

29. The method according to any one of the preceding items further comprising providing a back side element (11) on which the back cork layer (112) is applied prior to applying pressure and heat to form said panel, wherein the back cork layer (112) is configured to attach to the back side element (11) when pressure and heat is applied to form said panel.

30. The method according to item 29, wherein the back side element (11) is chosen from a group consisting of: a paper sheet, a resin impregnated paper sheet, a polymer-based sheet, a prefabricated powder-based sheet or a powder layer comprising wood fibres and binder.

31. The method according to item 30, wherein the back side element (11) is a wood veneer element.

32. The method according to any one of the preceding items, further comprising:
creating a mechanical locking device (30a; 30b) along at least one edge portion (25, 26, 27, 28) of the building panel (10), wherein the mechanical locking device (30a; 30b) is configured for horizontal and/or vertical locking of similar or essentially identical building panels (10) in an assembled position, the mechanical locking device (30a; 30b) comprising
an upper surface (40a; 60a), which is arrange in a front side area (26b; 28b) of the at least one edge portion (25, 26, 27, 28), which extends in an essentially parallel direction to a top surface (24), along at least one edge portion (25, 26, 27, 28), of the building panel (10), and which is displaced from said top surface (24), wherein the upper surface (40a; 60a) is arranged in the front side layer (19).

33. The method according to item 32, wherein the mechanical locking device (30a; 30b) further comprises:
a locking strip (32; 52) with a locking element (34; 54), arranged in a back side area (26a; 28a) of the at least one edge portion (25, 26, 27, 28) and which extends in an essentially parallel direction to a back surface (29), along at least one edge portion (25, 26, 27, 28), of the building panel (10), wherein the locking strip (32; 52) and the locking element (34:54) are arranged at least partly in the back side layer (15).

34. The method according to item 33, wherein at least 60%, or at least 80% of the locking strip (32; 52) and the locking element (34; 54) are created in the back side layer (15).

35. The method according to any one of the preceding items, wherein the building panel is a floor panel, a wall panel, or a furniture component.

36. A building panel (10), such as a floor panel, a wall panel, or a furniture component, comprising
a multi-layered substrate (14) comprising
   a back side layer (15) comprising lignocellulosic particles and a binder,
   an intermediate layer (17) comprising lignocellulosic particles and a binder, arranged on the back side layer (15),
   a front side layer (19) comprising lignocellulosic particles and a binder, arranged on the intermediate layer (17), wherein an average particle size of the lignocellulosic particles in the intermediate layer (17) is greater than an average particle size of the lignocellulosic particles in the back side layer (15) and/or the front side layer (19), and
   a front cork layer (102) comprising cork particles (101), arranged on the front side layer (19), optionally wherein a surface of the front cork layer (102) opposite the front side layer (19) is substantially free from added binder.

37. The building panel according to item 36, wherein an average particle size of the lignocellulosic particles in the intermediate layer (17) is greater than an average particle size of the lignocellulosic particles in the back side layer (15) and/or the front side layer (19).

38. The building panel according to item 36 or 37, wherein at least 50% of the lignocellulosic particles of the intermediate layer (17) have an aspect ratio of between 1:1 and 30:1.

39. The building panel according to any one of items 36-38, wherein the back side layer (15) is formed from a first mixture of the lignocellulosic particles and the binder, the intermediate layer (17) is formed from a second mixture of the lignocellulosic particles and the binder, and the front side layer (19) is formed from a third mixture of the lignocellulosic particles and the binder.

40. The building panel according to any one of items 36-39, wherein the cork particles comprise granulated cork material.

41. The building panel according to any one of items 36-41, wherein the front cork layer (102) is attached to the front side layer (19) by the binder of the third mixture.

42. The building panel according to any one of items 36-42, wherein the cork particles (101) are bonded to each other at least partly by natural resins of the cork particles (101).

43. The building panel according to any one of items 36-43, wherein the cork particles (101) are bonded to each other at least partly by the binder of the front side layer (19).

44. The building panel according to any one of items 36-44, wherein the cork particles (101) are bonded to the front side layer (19) at least partly by the binder of the front side layer (19).

45. The building panel according to any one of items 36-45, a thickness of the front cork layer (102) is 0.5-1 mm.

46. The building panel according to any one of items 36-46, wherein cork particles (101) from the front cork layer (102) and lignocellulosic particles from the front side layer (19) are mixed, at least in a border area (103) between the front cork layer (102) and the front side layer (19).

47. The building panel according to any one of items 36-47, further comprising a front side element (21) attached to the front cork layer (102).

48. The building panel according to item 47, wherein the front side element (21) is chosen from a group consisting of: a wood veneer element, a paper sheet, a resin impregnated paper sheet, a polymer-based sheet, a prefabricated powder-based sheet, or a powder layer comprising wood fibres and binder.

49. The building panel according to any one of items 36-48, further comprising a back cork layer (112) comprising cork particles (111), arranged on the back side layer (15), wherein a surface of the back cork layer (112), opposite the back side layer (15), is free from added binder.

50. The building panel according to any one of items 36-49, wherein lignocellulosic particles from the second mixture and lignocellulosic particles from the third mixture are mixed, at least in a border area (18b) between the intermediate layer (17) and the front side layer (19).

51. The building panel according to item 50, wherein lignocellulosic particles from the second mixture and lignocellulosic particles from the first mixture are mixed, at least in a border area (18a) between the intermediate layer (17) and the back side layer (15).

52. The building panel according to any one of items 36-51, wherein at least 50% of the lignocellulosic particles in the first and/or third mixture has an aspect ratio of between 1:1 and 20:1, or between 1:1 and 10:1.

53. The building panel according to any one of the items 36-52, further comprising a front side element (21) attached to the front cork layer (102) of the multi-layered substrate (14).

54. The building panel according to item 53, wherein the front side element (21) is chosen from a group consisting of: a paper sheet, a resin impregnated paper sheet, a polymer-based sheet, a prefabricated powder-based sheet or a powder layer comprising wood fibres and binder.

55. The building panel according to item 54, wherein the front side element (21) is a wood veneer element.

56. The building panel according to any one of the items 36-55, further comprising a back side element (11) attached to the back cork layer (112) of the multi-layered substrate (14).

57. The building panel according to item 56, wherein the back side element (11) is chosen from a group consisting of: a paper sheet, a resin impregnated paper sheet, a polymer-based sheet, a prefabricated powder-based sheet or a powder layer comprising wood fibres and binder.

58. The building panel according to item 57, wherein the back side element (11) is a wood veneer element.

59. The building panel according to any one of the items 36-58, further comprising:
a mechanical locking device (30a; 30b) arranged along at least one edge (25, 26, 27, 28) of the building panel, wherein the mechanical locking device (30a; 30b) is configured for horizontal and/or vertical locking of similar or essentially identical building panels (10, 10′, 10″) in an assembled position, the mechanical locking device (30a; 30b) comprising
an upper surface (40a; 60a), which is arranged in a front side area (26b; 28b) of the at least one edge (25, 26, 27, 28), which extends in an essentially parallel direction to a top surface (24), along at least one edge (25, 26, 27, 28), of the building panel, and which is displaced from said top surface (24), wherein the upper surface (40a; 60a) is further arranged in the front side layer (19) of the building panel (10).

60. The building panel according to item 59, wherein the mechanical locking device further comprises:
a locking strip (32; 52) with a locking element (34; 54), which is arranged in a back side area (26a; 28a) of the at least one edge (25, 26, 27, 28) and which extends in an essentially parallel direction to a back surface (29), along at least one edge (25, 26, 27, 28), of the building panel, wherein the locking strip (32; 52) and the locking element (34; 54) are arranged at least partly in the back side layer (15) of the building panel (10).

61. The building panel according to item 60, wherein the locking strip (32; 52) and the locking element (34; 54) are arranged in the back side layer (15), such that at least 60%, or at least 80% of the locking strip (32; 52) and the locking element (34; 54) are arranged in the back side layer (15).

62. The building panel according to any one of the items 36-61, wherein the panel is a floor panel, a wall panel, or a furniture component.

1. A method of producing a building panel, comprising:
applying a back side layer comprising a first mixture of at least lignocellulosic particles and a binder,
applying an intermediate layer comprising a second mixture of at least lignocellulosic particles and a binder, on the back side layer,
applying a front side layer comprising a third mixture of at least lignocellulosic particles and a binder, on the intermediate layer,
applying a front cork layer by applying cork particles on the front side layer prior to applying pressure and heat, and
applying pressure and heat to the back side layer, the intermediate layer, the front side layer, and the front cork layer, thereby forming the building panel.

2. The method according to claim 1, wherein an average particle size of the lignocellulosic particles in the second mixture is greater than an average particle size of the lignocellulosic particles in the first and/or third mixture.

3. The method according to claim 1, wherein at least 50% of the lignocellulosic particles in the second mixture has an aspect ratio of between 1:1 and 30:1.

4. The method according to claim 1, wherein the cork particles are applied on the front side layer as granulated cork material.

5. The method according to claim 1, wherein the cork particles are applied on the front side layer without adding any binder.

6. The method according to claim 1, wherein the front cork layer consists of the cork particles prior to applying pressure and heat.

7. The method according to claim 1, wherein a surface of the front cork layer opposite the front side layer is substantially free from added binder after applying pressure and heat.

8. The method according to claim 1, wherein the front cork layer is attached to the front side layer by the binder of the third mixture.

9. The method according to claim 1, wherein the cork particles are bonded to each other when pressure and heat is applied at least partly by natural resins of the cork particles.

10. The method according to claim 1, wherein the cork particles are bonded to each other when pressure and heat is applied at least partly by the binder of the third mixture.

11. The method according to claim 1, wherein the cork particles are bonded to the front side layer at least partly by the binder of the third mixture.

12. The method according to claim 1, wherein a thickness of the front cork layer is 0.5-1 mm after applying pressure and heat.

13. The method according to claim 1, further comprising applying a front side element on the front cork layer prior to applying pressure and heat, wherein the front side element is configured to be attached to the front cork layer when pressure and heat is applied to form the building panel.

14. The method according to claim 13, wherein the front side element is chosen from a group consisting of: a wood veneer element, a paper sheet, a resin impregnated paper sheet, a polymer-based sheet, a prefabricated powder-based sheet, and a powder layer comprising wood fibres and binder.

15. The method according to claim 1, further comprising applying a back cork layer by applying cork particles on a carrier, and applying the back side layer on the back cork layer.

16. The method according to claim 15, wherein the cork particles are applied on the carrier as granulated cork material.

17. A building panel comprising
a multi-layered substrate comprising
a back side layer comprising lignocellulosic particles and a binder,
an intermediate layer comprising lignocellulosic particles and a binder, arranged on the back side layer,
a front side layer comprising lignocellulosic particles and a binder, arranged on the intermediate layer, and
a front cork layer comprising cork particles, arranged on the front side layer, wherein a surface of the front cork layer opposite the front side layer is substantially free from added binder.

18. The building panel according to claim 17, wherein an average particle size of the lignocellulosic particles in the intermediate layer is greater than an average particle size of the lignocellulosic particles in the back side layer and/or the front side layer.

19. The building panel according to claim 17, wherein at least 50% of the lignocellulosic particles of the intermediate layer have an aspect ratio of between 1:1 and 30:1.

20. The building panel according to claim 17, wherein the back side layer is formed from a first mixture of the lignocellulosic particles and the binder, the intermediate layer is formed from a second mixture of the lignocellulosic particles and the binder, and the front side layer is formed from a third mixture of the lignocellulosic particles and the binder.

21. The building panel according to claim 17, wherein the cork particles comprise granulated cork material.

22. The building panel according to claim 17, wherein the front cork layer is attached to the front side layer by the binder of the third mixture.

23. The building panel according to claim 17, wherein the cork particles are bonded to each other at least partly by natural resins of the cork particles.

24. The building panel according to claim 17, wherein the cork particles are bonded to each other at least partly by the binder of the front side layer.

25. The building panel according to claim 17, wherein the cork particles are bonded to the front side layer at least partly by the binder of the front side layer.

26. The building panel according to claim 17, wherein a thickness of the front cork layer is 0.5-1 mm.

27. The building panel according to claim 17, further comprising a front side element attached to the front cork layer.

28. The building panel according to claim 27, wherein the front side element is chosen from a group consisting of: a wood veneer element, a paper sheet, a resin impregnated paper sheet, a polymer-based sheet, a prefabricated powder-based sheet, and a powder layer comprising wood fibres and binder.

29. The building panel according to claim 17, further comprising a back cork layer comprising cork particles, arranged on the back side layer, wherein a surface of the back cork layer, opposite the back side layer, is free from added binder.
